(19) United States
(12) Patent Application Publication
(10) Pub. No.: US 2016/0140675 A1
(43) Pub. Date: May 19, 2016

(54) Method and System for Increasing Utilization of Hotel Hospitality User Services

(71) Applicant: Marc Nathan London, Collierville, TN (US)

(72) Inventor: Marc Nathan London, Collierville, TN (US)

(21) Appl. No.: 14/941,266

(22) Filed: Nov. 13, 2015

Related U.S. Application Data
(60) Provisional application No. 62/080,058, filed on Nov. 14, 2014.

(51) Int. Cl. G06Q 50/12; G06F 3/0482; G06Q 30/00

(52) U.S. Cl. CPC G06Q 50/12; G06Q 30/016; G06F 3/0482

(57) ABSTRACT

The disclosure provides a method and system for increasing utilization of hotel hospitality user services by hotel guest users.

### CROSS-REFERENCE TO RELATED APPLICATIONS

This application claims priority to U.S. Provisional Patent Application No. 62/080,058, filed Nov. 14, 2014, which is hereby incorporated by reference it its entirety.

### FIELD OF THE INVENTION

The present disclosure relates to a method and system including hospitality services, more specifically a method and system for increasing utilization of hotel hospitality user services.

### BACKGROUND OF THE INVENTION

The disclosed subject matter provides a method and system for increasing utilization of hotel hospitality user services. The system may utilize electronic devices, such as a cellular phone, or a similar electronic device to provide information and services efficiently.

### BRIEF SUMMARY OF THE INVENTION

The disclosure provides a method and system for increasing utilization of hotel hospitality user services. The system may utilize electronic devices, such as a cellular phone, or a similar electronic device to provide information and services efficiently.

In certain embodiments, the method and system may be used in conjunction with a hotel. The system may provide to a user the ability to access information and services efficiently for one or more hotels. The system may use a similar interface for different hotels and hotel chains. In certain embodiments, the above task may be carried out in conjunction with a cell phone application.

### BRIEF DESCRIPTION OF THE DRAWINGS

The novel features believed characteristic of the disclosed subject matter will be set forth in any claims that are filed later. The disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1 displays one embodiment of a computing system and related peripherals that may operate with the method and system for increasing utilization of hotel hospitality user services.

FIG. 2 displays a method for increasing utilization of hotel hospitality user services in accordance with embodiments.

FIG. 3 displays a system for increasing utilization of hotel hospitality user services in accordance with embodiments.

FIG. 4A displays aspects of a system in accordance with embodiments.

FIG. 4B displays additional aspects of a system in accordance with embodiments.

FIG. 5 displays one embodiment of an electronic device screen displaying an embodiment of a system application.

FIG. 6 displays one embodiment of a direct dial screen on an electronic device.

FIG. 7 displays one embodiment of a concierge screen on an electronic device.

FIG. 8 displays one embodiment of a recommendations screen on an electronic device.

FIG. 9 displays one embodiment of a choose hotel screen on an electronic device.

FIG. 10 displays one embodiment of a valet services screen on an electronic device.

FIG. 11 displays one embodiment of a taxi services screen on an electronic device.

FIG. 12 displays one embodiment of a lobby screen on an electronic device.

FIG. 13A displays one embodiment of a home screen for an application on an electronic device.

FIG. 13B displays one embodiment of a hotel suggestion screen on an electronic device.

FIG. 14A displays one embodiment of an options screen on an electronic device.

FIG. 14B displays one embodiment of an options screen on an electronic device.

FIG. 14C displays one embodiment of an options screen on an electronic device.

FIG. 15 displays one embodiment of a dialer screen on an electronic device.

FIG. 16A displays one embodiment of a business weekly meal revenue graph.

FIG. 16B displays one embodiment of a business restaurant customer satisfaction line graph.

FIG. 16C displays one embodiment of a business weekly profit/loss margins graph.

FIG. 17A displays one embodiment of a lobby screen on an electronic device.

FIG. 17B displays one embodiment of a lobby screen on an electronic device.

FIG. 18 displays one embodiment of a valet services screen on an electronic device.

FIG. 19A displays one embodiment of a messages screen on an electronic device.

FIG. 19B displays one embodiment of a messages screen on an electronic device.

FIG. 20 displays one embodiment of an events screen on an electronic device.

FIG. 21 displays one embodiment of a conference screen on an electronic device.

FIG. 22 displays one embodiment of a feedback screen on an electronic device.

FIG. 23 displays one embodiment of a lobby buttons manager screen on an electronic device.

FIG. 24 displays one embodiment of a tracking analysis manager screen on an electronic device.

FIG. 25 displays one embodiment of an event form manager screen on an electronic device.

FIG. 26 displays one embodiment of a reports and form manager screen on an electronic device.

### DETAILED DESCRIPTION OF ILLUSTRATIVE EMBODIMENTS

Reference now should be made to the drawings, in which the same reference numbers are used throughout the different figures to designate the same components.

It will be understood that, although the terms first, second, third, etc. may be used herein to describe various elements, these elements should not be limited by these terms. These terms are only used to distinguish one element from another element. Thus, a first element discussed below could be termed a second element without departing from the teachings of the present disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although described with reference to personal computers and the Internet, one skilled in the art could apply the principles discussed herein to any computing or mobile computing environment. Further, one skilled in the art could apply the principles discussed herein to communication mediums beyond the Internet.

It will be appreciated that for simplicity and clarity of illustration, where considered appropriate, reference numerals may be repeated among the figures to indicate corresponding or analogous elements. In addition, numerous specific details are set forth in order to provide a thorough understanding of the implementations described herein. However, it will be understood by those of ordinary skill in the art that the implementations described herein may be practiced without these specific details. In other instances, well-known methods, procedures and components have not been described in detail so as not to obscure the implementations described herein. Also, the description is not to be considered as limiting the scope of the implementations described herein.

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

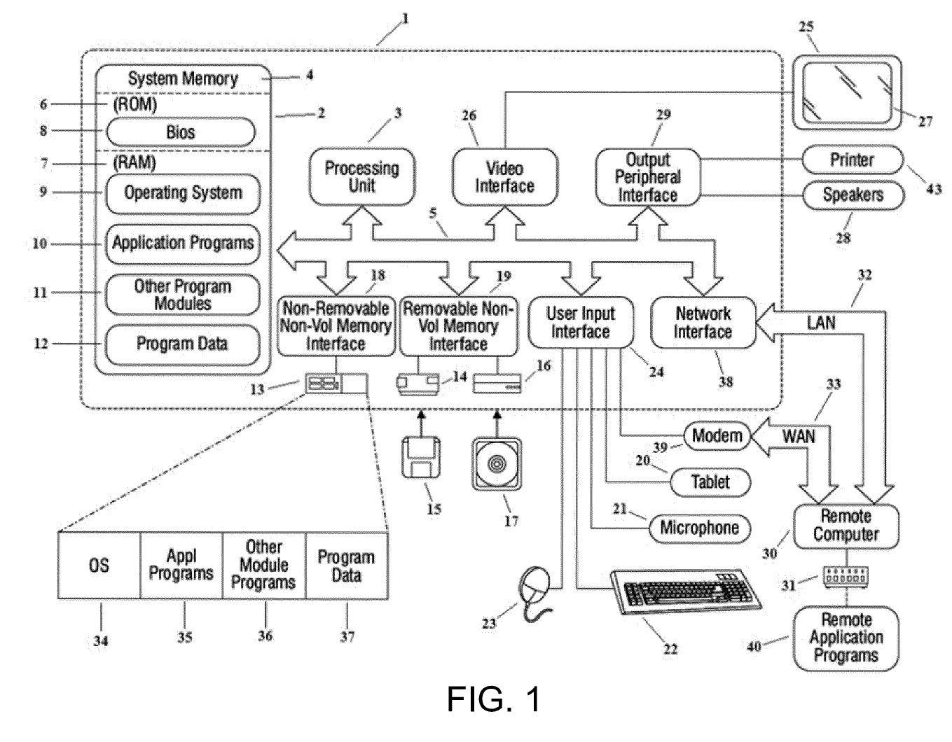

With reference to FIG. 1, an exemplary system within a computing environment for implementing the disclosure includes a general purpose computing device in the form of a computing system 1, commercially available from, for example, Intel, IBM, AMD, Motorola, Cyrix, etc. Components of the computing system 2 may include, but are not limited to, a processing unit 3, a system memory 4, and a system bus 5 that couples various system components including the system memory 4 to the processing unit 3. The system bus 5 may be any of several types of bus structures including a memory bus or memory controller, a peripheral bus, or a local bus using any of a variety of bus architectures.

Computing system 1 typically includes a variety of computer readable media. Computer readable media can be any available media that can be accessed by the computing system 1 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing system 1.

The system memory 4 includes computer storage media in the form of volatile and/or nonvolatile memory such as read only memory (ROM) 6 and random access memory (RAM) 7. A basic input/output system (BIOS) 8, containing the basic routines that help to transfer information between elements within computing system 1, such as during start-up, is typically stored in ROM 6. RAM 7 typically contains data and/or program modules that are immediately accessible to and/or presently being operated on by processing unit 3. By way of example, and not limitation, an operating system 9, application programs 10, other program modules 11, and program data 12 are shown.

Computing system 1 may also include other removable/non-removable, volatile/nonvolatile computer storage media. By way of example only, a hard disk drive 13 that reads from or writes to non-removable, nonvolatile magnetic media, a magnetic disk drive 14 that reads from or writes to a removable, nonvolatile magnetic disk 15, and an optical disk drive 16 that reads from or writes to a removable, nonvolatile optical disk 17 such as a CD ROM or other optical media could be employed to store the invention of the present embodiment. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 13 is typically connected to the system bus 5 through a non-removable memory interface such as interface 18, and magnetic disk drive 14 and optical disk drive 16 are typically connected to the system bus 5 by a removable memory interface, such as interface 19.

The drives and their associated computer storage media, discussed above, provide storage of computer readable instructions, data structures, program modules and other data for the computing system 1. For example, hard disk drive 13 is illustrated as storing operating system 34, application programs 35, other program modules 36, and program data 37. Note that these components can either be the same as or different from operating system 9, application programs 10, other program modules 11, and program data 12. Operating system 34, application programs 35, other program modules 36, and program data 37 are given different numbers here to illustrate that, at a minimum, they are different copies.

A user may enter commands and information into the computing system 1 through input devices such as a tablet, or electronic digitizer, 20, a microphone 21, a keyboard 22, and pointing device 23, commonly referred to as a mouse, trackball, or touch pad. These and other input devices are often connected to the processing unit 3 through a user input interface 24 that is coupled to the system bus 5, but may be connected by other interface and bus structures, such as a parallel port, game port or a universal serial bus (USB).

A monitor 25 or other type of display device is also connected to the system bus 5 via an interface, such as a video interface 26. The monitor 25 may also be integrated with a touch-screen panel 27 or the like. Note that the monitor and/or touch screen panel can be physically coupled to a housing in which the computing system 1 is incorporated, such as in a tablet-type personal computer. In addition, computers such as the computing system 1 may also include other peripheral output devices such as speakers 28 and printer 43, which may be connected through an output peripheral interface 29 or the like.

Computing system 1 may operate in a networked environment using logical connections to one or more remote computers, such as a remote computing system 30. The remote computing system 30 may be a personal computer (including, but not limited to, mobile electronic devices), a server, a router, a network PC, a peer device or other common network node, and typically includes many or all of the elements described above relative to the computing system 1, although only a memory storage device 31 has been illustrated. The logical connections depicted include a local area network (LAN) 32 connecting through network interface 38 and a wide area network (WAN) 33 connecting via modem 39, but may also include other networks. Such networking environments are commonplace in offices, enterprise-wide computer networks, intranets, and the Internet.

For example, in the present embodiment, the computer system 1 may comprise the source machine from which data is being generated/transmitted and the remote computing system 30 may comprise the destination machine. Note however that source and destination machines need not be connected by a network or any other means, but instead, data may be transferred via any media capable of being written by the source platform and read by the destination platform or platforms.

In another example, in the present embodiment, the remote computing system 30 may comprise the source machine from which data is being generated/transmitted and the computer system 1 may comprise the destination machine.

In a further embodiment, in the present disclosure, the computing system 1 may comprise both a source machine from which data is being generated/transmitted and a destination machine and the remote computing system 30 may also comprise both a source machine from which data is being generated/transmitted and a destination machine.

Referring to FIG. 1, for the purposes of this disclosure, it will be appreciated that remote computer 30 may include any suitable terms such as, but not limited to “device”, “processor based mobile device”, “mobile device”, “electronic device”, “processor based mobile electronic device”, “mobile electronic device”, “wireless electronic device”, “location-capable wireless device,” and “remote device” including a smart phone or tablet computer.

The central processor operating pursuant to operating system software such as, but not limited to Apple IOS®, Google Android®, IBM OS/2®, Linux®, UNIX®, Microsoft Windows®, Apple Mac OSX®, and other commercially available operating systems provides functionality for the services provided by the present invention. The operating system or systems may reside at a central location or distributed locations (i.e., mirrored or standalone).

Software programs or modules instruct the operating systems to perform tasks such as, but not limited to, facilitating client requests, system maintenance, security, data storage, data backup, data mining, document/report generation, and algorithm generation. The provided functionality may be embodied directly in hardware, in a software module executed by a processor, or in any combination of the two.

Furthermore, software operations may be executed, in part or wholly, by one or more servers or a client's system, via hardware, software module, or any combination of the two. A software module (program or executable) may reside in RAM memory, flash memory, ROM memory, EPROM memory, EEPROM memory, registers, hard disk, a removable disk, a CD-ROM, DVD, optical disk, or any other form of storage medium known in the art. An exemplary storage medium is coupled to the processor such that the processor can read information from, and write information to, the storage medium. In the alternative, the storage medium may be integral to the processor. The processor and the storage medium may also reside in an application specific integrated circuit (ASIC). The bus may be an optical or conventional bus operating pursuant to various protocols that are well known in the art.

All methods described herein can be performed in a suitable order unless otherwise indicated herein or otherwise clearly contradicted by context. The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

The detailed description set forth herein in connection with the appended drawings is intended as a description of exemplary embodiments in which the presently disclosed apparatus and system can be practiced. The term “exemplary” used throughout this description means “serving as an example, instance, or illustration,” and should not necessarily be construed as preferred or advantageous over other embodiments.

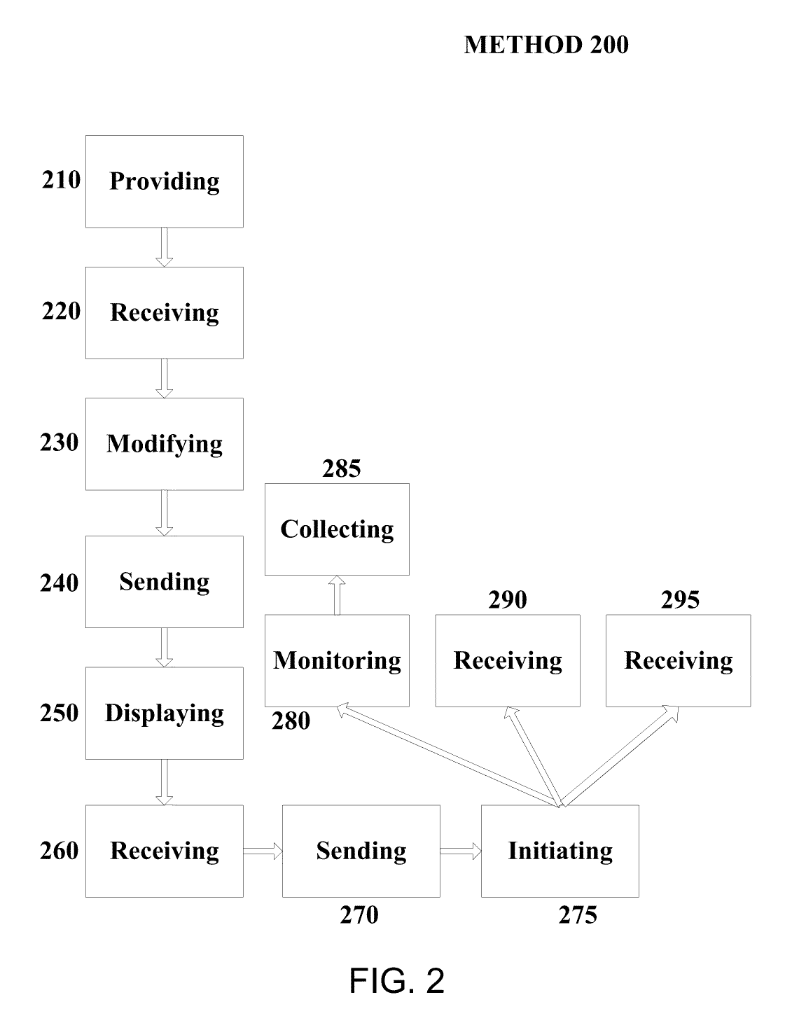

FIG. 2 displays a method 200 for increasing utilization of hotel hospitality user services in accordance with embodiments. The hotel hospitality user services 335 may be utilized by hotel guest users. The method may comprise providing 210 a hotel managing interface 325 via a server 305. The hotel managing interface 325 may comprise an application protocol interface that may be accessible via a graphical user interface on a hotel electronic device 330, such as, but not limited to a desktop computer and a mobile electronic device. The hotel managing interface 325 may include a configuration adapted to receive and modify identified user service input 340 relating to at least one identified hotel hospitality user service 335.

Identified user service input may then be received 220 via the hotel managing interface 325. In embodiments, the identified user service input may be determined in relation to predicted utilization of at least one of the hotel hospitality user services 335 by an identified hotel guest user. In embodiments, the identified user service input 340 may be determined via a processor by determining correlation between at least one of the hotel hospitality user services 335 and user information 345 for the identified hotel guest user.

The hotel managing interface 325 may then modify 230 the identified user service input 340 in order to create at least one modifiable graphical interface component 350. The server may then send 240, over the network to a user mobile electronic device 320 associated with the identified hotel guest user, the at least one modifiable graphical interface component 350. In order to receive the at least one modifiable graphical interface component 350, the user mobile electronic device 320 may include a user receiving interface comprising a graphical user interface.

Method 200 may further comprise displaying 250, via a display of the user mobile electronic device 320, the at least one modifiable graphical interface component 350. Each of the at least one modifiable graphical interface component 350 may include at least one link to the at least one of the hotel hospitality user services 335. In embodiments, the at least one link may be selected from the group consisting of a website URL, an email link, a telephonic link, and a modifiable form link. In embodiments, the hotel hospitality user services 335 may be services that may typically utilized within a hotel atmosphere. In embodiments, data for each of the services 335 may be accessible to an employee that may deal with specific services 335. In embodiments, links may be sent directly to employees of specific services 335.

User input relating to the at least one modifiable graphical interface component 350 may then be received 260 at the user mobile electronic device 320. In embodiments, the user input may include information such as, but not limited to questions and answers to questions. The user input relating to the at least one modifiable graphical interface component 350 may then be sent 270 from the user mobile electronic device 320 over the network to the server 305.

Method 200 may further comprise initiating 275, via the server, delivery of the at least one of the hotel hospitality user services 335 to the identified hotel guest user. Utilization of hotel hospitality user services 335 by a plurality of hotel guest users may be increased by recurring the initiating step for each of a plurality of identified hotel guest users.

In embodiments, method 200 may further comprise monitoring 280 and collecting 285, via a user content tracking device, user input information on the user mobile electronic device 320 and user electronic device location information. In embodiments, the at least one modifiable graphical interface component 350 may be modifiable in response to the information collected via the user content tracking device.

In embodiments, method 200 may further comprise receiving 290, via the user receiving interface, at least one specific modifiable graphical interface component 350 in response to a unique user code input. The unique user code input may provide protocol to the hotel managing interface 325 for sending the at least one specific modifiable graphical interface component 350.

In embodiments, method 200 may further comprise receiving 295, via the user receiving interface, at least one specific modifiable graphical interface component 350 in response to a geographical location of the user mobile electronic device 320. For example, if a user were to walk into the lobby of a hotel, data in the form of a specific modifiable graphical interface component 350 representative of a concierge service may be sent from the server 305. The sending of data may be triggered by the sending of an automatic request from the user mobile electronic device 320 to the server 305. The request may be sent automatically based on protocol stored on the user mobile electronic device 320 that may send a request once the geographical location of the user mobile electronic device 320 is recognized as being in a specific location or area via GPS, etc. Once the server 305 receives the request, the server 305 may follow protocol stored on the server 305 to send back to the user mobile electronic device 320 the specific modifiable graphical interface component 350 representative of a concierge service.

In embodiments, the identified user service input 340 may comprise interactive notifications. For example, the identified user service input 340 may be sent to a hotel guest within an interactive notification. The guest user may provide identified user service input within engageable graphical components that may be sent back to the server 305. In embodiments, the interactive notifications may be received by the user mobile electronic device 320 in response to the location of the user mobile electronic device 320 within a local network of a hotel.

In embodiments, the hotel managing interface 325 may be capable of altering destinations of a user response in response to the at least one of a website link, an email link, a telephonic link, and a modifiable form link based on an employee availability credential. For example, an employee may be logged into the hotel managing interface using employee credentials. The hotel managing interface 325 may comprise protocol that may direct a user response to an employee access point (such as, but not limited to a mail server) when the employee is logged in. When the employee logs out and another employee logs in (with the second employee having the same or a similar occupation at the hotel), the server 305 may comprise protocol that may then restrict a user response from getting sent to the first employee's access point and may send the user response to a second employee access point.

In embodiments, data provided to the user electronic device may be stored on the memory 315. In embodiments, the server 305 may comprise the memory 315. In embodiments, the memory 315 may be linked to the server 305.

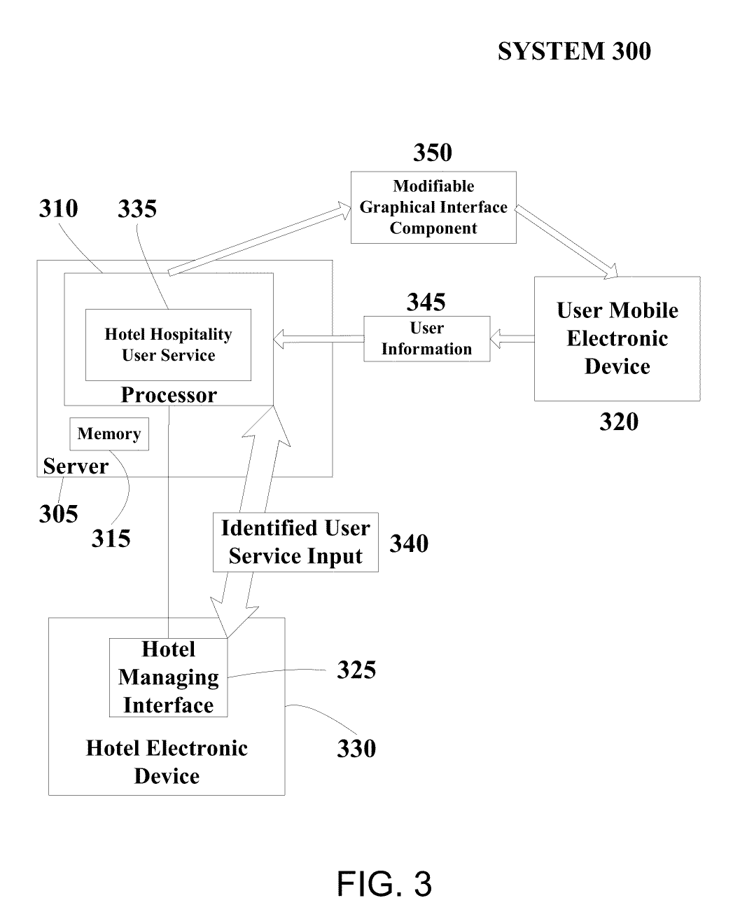

FIG. 3 displays a system 300 for increasing utilization of hotel hospitality user services in accordance with embodiments. System 300 may comprise a server 305 having a processor 310, that may provide a hotel managing interface 325, In embodiments, the hotel managing interface 325 may comprise an application protocol interface that may be accessible via a graphical user interface on a hotel electronic device 330. The hotel managing interface 325 may have a configuration adapted to receive and modify identified user service input 340. In embodiments, the identified user service input 340 may relate to at least one identified hotel hospitality user service 335. In embodiments, an identified hotel hospitality user service 335 may be a service offered to a guest of a hotel.

The hotel managing interface 325 may receive identified user service input 340 that may be determined in relation to predicted utilization of at least one of the hotel hospitality user services 335 by an identified hotel guest user. In embodiments, the identified user service input 340 may be determined via the processor 310 by determining correlation between the at least one of the hotel hospitality user services 335 and user information 345 for the identified hotel guest user. In embodiments, user information 345 may be sent to the processor 310 from a user mobile electronic device 320.

The processor 310 may create at least one modifiable graphical interface component 350 by modifying the identified user service input. In embodiments, the at least one modifiable graphical interface component 350 may be an electronic device application sent to the user mobile electronic device 320 in the form of data.

The server 305 may send over the network to a user mobile electronic device 320 associated with the identified hotel guest user, at least one modifiable graphical interface component 350. In embodiments, the user mobile electronic device 320 may have a user receiving interface comprising a graphical user interface. In embodiments, the graphical user interface may allow for interaction between a user and at least one modifiable graphical interface components 350.

The user mobile electronic device 320 may have a display that may display the at least one modifiable graphical interface component 350. Each of the at least one modifiable graphical interface component 350 may comprise at least one link to the at least one of the hotel hospitality user services 335. In embodiments, the at least one link may be selected from the group consisting of a website URL, an email link, a telephonic link, and a modifiable form link.

In embodiments, the user mobile electronic device 320 may receive, via the user receiving interface, user input relating to the at least one modifiable graphical interface component 350.

In embodiments, the user electronic device may send over the network, to the server 305, the user input relating to the at least one modifiable graphical interface component 350.

In embodiments, the server 305 may initiate delivery of the at least one of the hotel hospitality user services 335 to the identified hotel guest user. The initiating may be determined by the processor 310 correlating the at least one modifiable graphical interface component 350 in relation to the at least one of the hotel hospitality user services 335 and in relation to the identified hotel guest user. In embodiments, utilization of hotel hospitality user services 335 by a plurality of hotel guest users may be increased by recurring the initiating for each of a plurality of identified hotel guest users.

In embodiments, a user content tracking device may monitor and collect user input information on the user mobile electronic device 320 and user electronic device location information. In embodiments, the at least one modifiable graphical interface component 350 may be modifiable in response to the information collected via the user content tracking device.

In embodiments, the user receiving interface may receive at least one specific modifiable graphical interface component 350 in response to a unique user code input. The unique user code input may provide protocol to the hotel managing interface 325 for sending the at least one specific modifiable graphical interface component 350.

In embodiments, the user receiving interface may receive at least one specific modifiable graphical interface component 350 in response to a geographical location of the user mobile electronic device 320. For example, if a user were to walk into the lobby of a hotel, data in the form of a specific modifiable graphical interface component representative of a concierge service may be sent from the server 305. The sending of data may be triggered by the sending of an automatic request from the user mobile electronic device 320 to the server 305. The request may be sent automatically based on protocol stored on the user mobile electronic device 320 that may send a request once the geographical location of the user mobile electronic device 320 is recognized as being in a specific location or area via GPS, etc. Once the server receives the request, the server 305 may follow protocol stored on the server to send back to the user mobile electronic device 320 the specific modifiable graphical interface component 350 representative of a concierge service.

In embodiments, the identified user service input 340 may comprise interactive notifications. For example, the identified user service input 340 may be sent to a hotel guest within an interactive notification. The guest user may provide identified user service input 340 within engageable graphical components that may be sent back to the server 305. In embodiments, the interactive notifications may be received by the user mobile electronic device 320 in response to the location of the user electronic device within a local network of a hotel.

In embodiments, the hotel managing interface 325 may be capable of altering destinations of a user response in response to the at least one of a website link, an email link, a telephonic link, and a modifiable form link based on an employee availability credential. For example, an employee may be logged into the hotel managing interface 325 using employee credentials. The hotel managing interface 325 may comprise protocol that may direct a user response to an employee access point (such as, but not limited to a mail server) when the employee is logged in. When the employee logs out and another employee logs in (with the second employee having the same or a similar occupation at the hotel), the server 305 may comprise protocol that may then restrict a user response from getting sent to the first employee's access point and may send the user response to a second employee access point.

In embodiments, data provided to the user electronic device may be stored on the memory 315. In embodiments, the server 305 may comprise the memory 315. In embodiments, the memory 315 may be linked to the server 305.

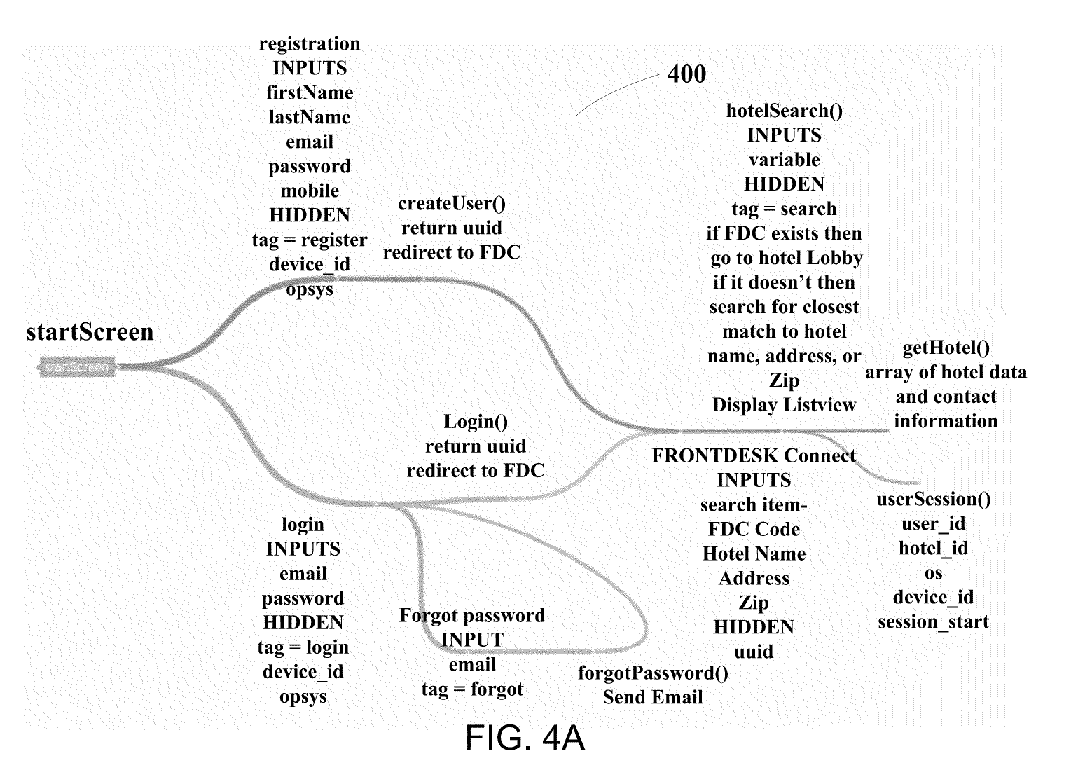

FIG. 4A displays aspects of a system 400 in accordance with embodiments. The aspects may include tasks that may correlate to steps taken by a user while perusing an application relative to the method and system for increasing utilization of hotel hospitality user services. The tasks may be in the form of code and may include at least one of commands and general data. Once a start screen on the application is initiated, a user may then (manually or automatically) be led to a registration screen, wherein specific inputs may be entered by a user in order to register with the system for increasing utilization of hotel hospitality user services. These inputs are denoted as and may include, but are not limited to: “firstName”, “lastName”, “email”, “password”, and “mobile”. For each screen, there are also specific hidden functions or tasks that may automatically be completed by the processor of the electronic device based on rules designated by the system. For the registration screen, these hidden functions or tasks may include, but are not limited to, “tag=register”, “device_id”, “opsys”, “createUser( )”, “return uuid”, and “redirect to FDC”.

After the user inputs specific information, the user may be led to a “FrontDesk Connect” screen, or generally a “search” screen, wherein the user may enter inputs such as, but not limited to: “search item”, “FDC code”, “Hotel Name”, “Address”, and “Zip”. The hidden functions for this screen may include, but are not limited to: “uuid”.

The user may be led to the “FrontDesk Connect” screen by another alternative route if the user is already associated with the system. The first screen the user may encounter is the “login” screen, wherein the user may enter inputs such as, but not limited to: “email” and “password”. The hidden functions for this screen may include, but are not limited to: “tag=login”, “device_id”, and “opsys”.

If a user does not remember their password, the user may request their password once they are brought to the “Forgot Password” screen. This screen may allow the user to enter inputs such as, but not limited to: “email”. The hidden functions for this screen may include, but are not limited to: “tag=forgot”. The processor may then “Send Email” to the user with the user's password; this hidden function may be denoted as “forgotPassword( )”.

If a user does remember their password, the user may enter their password on the “login” screen. The processor may then perform hidden tasks such as, but not limited to: “return uuid” and “redirect to FDC”. These hidden functions may be denoted as “login( )”. Once complete, the use may then be led to the “FrontDesk Connect” screen.

The “FrontDesk Connect” screen may allow a user to enter inputs such as, but not limited to: “search item”, “FDC Code”, “Hotel Name”, “Address”, and “Zip”. The hidden functions for this screen may include, but are not limited to: “uuid”.

FIG. 4B displays additional aspects of a system 400 in accordance with embodiments. Once the user is steered away from the “FrontDesk Connect” screen, the processor may perform a hotel search task based on the criteria entered by the user. At this point the user may or may not be led to a loading screen while the processor performs the hotel search task, which is denoted as “hotelSearch( )”. The inputs that may be entered by a user are variable. The hidden functions may include, but are not limited to: “tag=search”. If a “FrontDesk Connect” account exists for a certain hotel or hotel chain, the user may go to the lobby of the hotel that they had searched for. If a “FrontDesk Connect” account does not exist for a certain hotel or hotel chain, the n the user may search for the closest match to the desired hotel chosen by the user using one or more of a name, address, or zip. Another hidden function may include, but is not limited to: “Display Listview”.

Once the processor has completed its hotel search task, the processor may then perform one of two tasks or both tasks: start a user session, denoted as “userSession( )”, or get hotel information for the user, denoted as “getHotel( )”. When the user session is started, the processor may perform hidden functions such as, but not limited to: “user_id”, “hotel_id”, “os”, “device_id”, and “session_start”. Once the functions are completed, the processor may have information on the user's session.

When the “getHotel( )” task is initiated, the processor may collect an array of hotel data and contact information of the hotel pertinent to the hotel that the user had previously specified. The user may then be led to the “FRONTDESK Lobby” screen, wherein a directory for the hotel is displayed and links are buttons with telephone numbers. From the “FRONTDESK Lobby” screen, the user may be taken to either the “CONFERENCES” screen, the “MESSAGES” screen, or the “EVENTS” screen.

If the user is led to the “CONFERENCES” screen, the processor may perform hidden tasks such as, but not limited to: “conference_id”, “hotel_id”, “conference title”, “conference_description”, “conference_startdate”, “conference_enddate”, and “conference code”. Information pertinent to the hidden tasks may be displayed to the user. From the “CONFERENCES” screen, the user may be led to either the “CONFERENCE EVENT” screen or the “CONFERENCE MESSAGES” screen. If the user is led to the “CONFERENCE EVENT” screen, the processor may perform hidden tasks such as, but not limited to: “conf_event_id”, “conf_id”, “conf_event_time”, “conf_event_description”, “conf_event_startdate”, “conf_event_enddate”, “conf_event_starttime”, “conf_event_endtime”, and “conf_event_location”. If the user is led to the “CONFERENCE MESSAGES” screen, the processor may perform hidden tasks such as, but not limited to: “conf_id”, “conf_message_id”, “conf_message_title”, “conf_message_message”, “conf_message_coupon”, “conf_message_expiration”, and “conf_message_created”.

If the user is led to the “MESSAGES” screen, the processor may perform a “getMessages( )” task, wherein the processor may retrieve messages relative to the user's session and the message identifier. The hidden functions that may be performed include, but are not limited to: “hotel_id”, “title”, “message”, “coupon code”, “expiration”, and “created”. Once these functions are completed, the processor may then perform a “deleteMessage” task, wherein the processor may delete messages relative to the user based on a manual input from the user or when a message expires. The hidden functions that may be performed include, but are not limited to: “message_id” and “user_id”.

If the user is led to the “EVENTS” screen, the processor may perform a “getEvents( )” task, wherein the processor may retrieve tasks relative to the user's session and the event identifier. The hidden functions that may be performed include, but are not limited to: “hotel_id”, “event_title”, “event_description”, “event_datestart”, “event_dateend”, “event_timestart”, and “event_timeend”.

For clarity, the following paragraphs may describe in more detail (and in similar and different embodiments) the “screens” referenced in the above paragraphs.

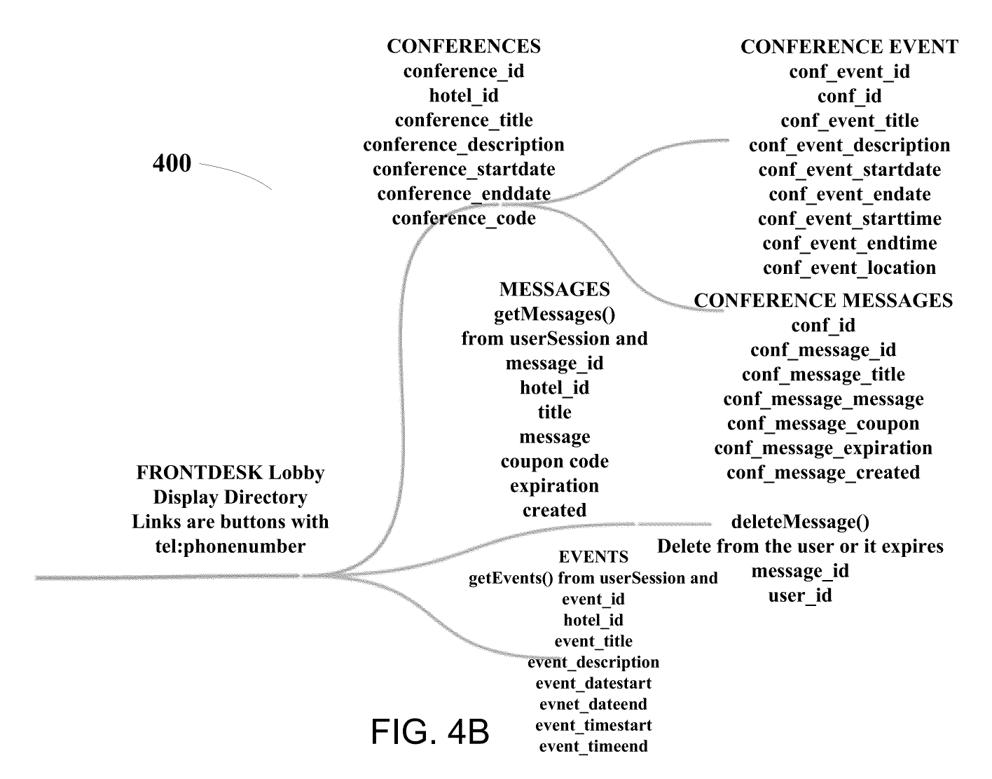

FIG. 5 displays one embodiment of an electronic device screen 500 displaying an embodiment of a system application 510. The system application 510 may be displayed as an icon on the screen 500 of an electronic device. The icon may be engageable by a user of the electronic device. The means of engagement may include, but is not limited to: touching the icon with an appendage of a user's body. Once the icon is engaged, the user may be led to screens representative of the method and system for increasing utilization of hotel hospitality user services.

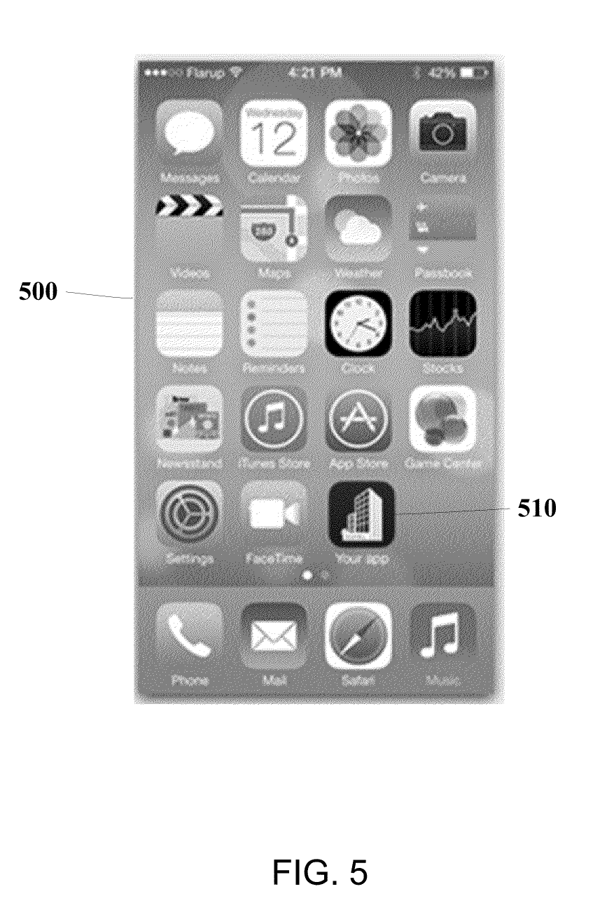

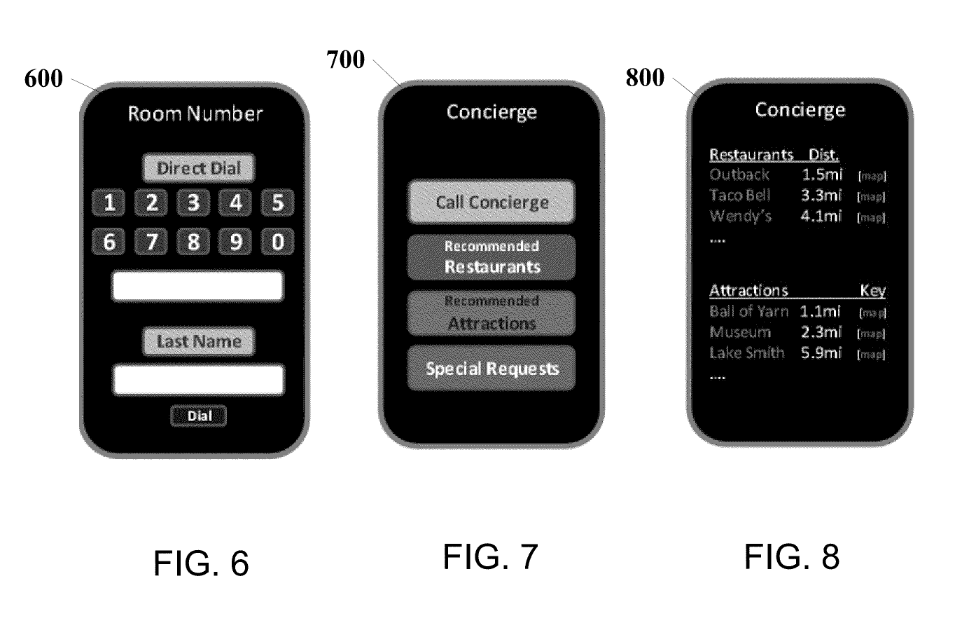

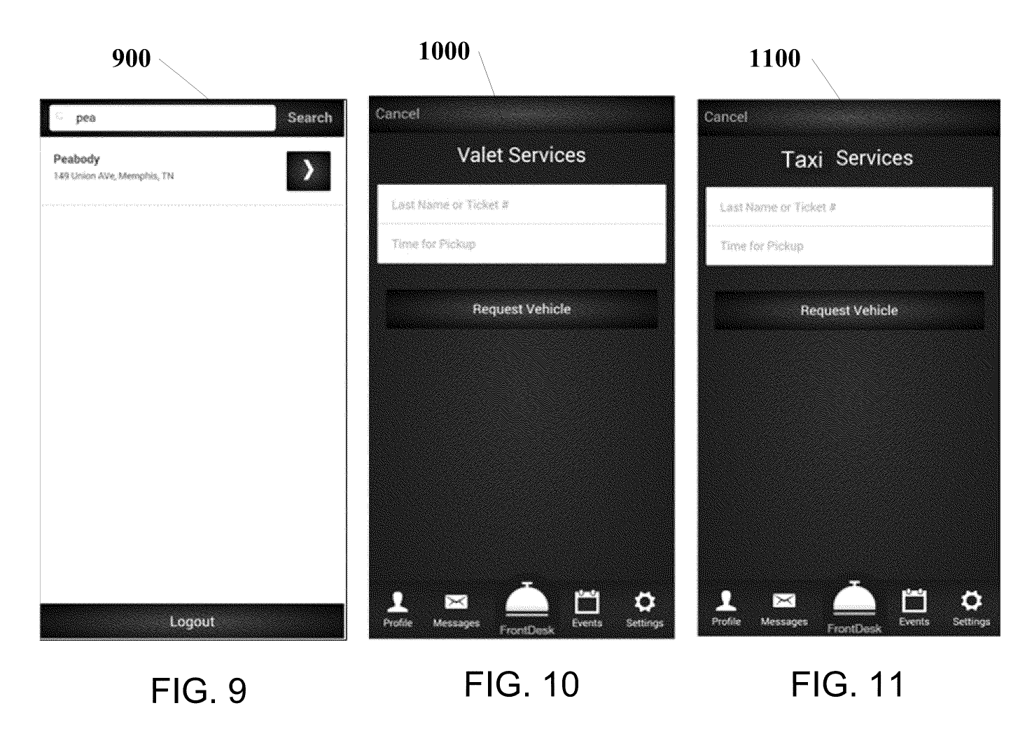

FIG. 6 displays one embodiment of a direct dial screen 600 on an electronic device. This direct dial screen 600 may be utilized by a user and may be used to contact people relevant to the hotel at which the user is staying. The user may enter a phone number or a number representative of a person relevant to the hotel and a last name of the person. The user may then engage the dial icon found at the bottom of screen 600 in order for the electronic device to attempt to contact the person. FIG. 7 displays one embodiment of a concierge screen 700 on an electronic device. Concierge screen 700 may be utilized by a user and may be used to request services or information from the hotel at which the user is staying. The icons that a user may engage include, but are not limited to: a “call concierge” icon, a “recommended restaurants” icon, a “recommended attractions” icon, and a “special requests” icon. The “call concierge” icon may allow the electronic device to attempt to connect to the concierge of the hotel. The “recommended restaurants” icon and the “recommended attractions” icon may allow a user to view a list of recommended restaurants or recommended attractions by the hotel on their electronic device. These lists may be found on the embodiment of the recommendations screen 800 found in FIG. 8. In certain embodiments, the recommended restaurants and recommended attractions may be displayed on separate screens of an electronic device. The “special requests” icon may allow a user to either view a screen with predetermined special requests or contact a person that may help the user take care of their special request.

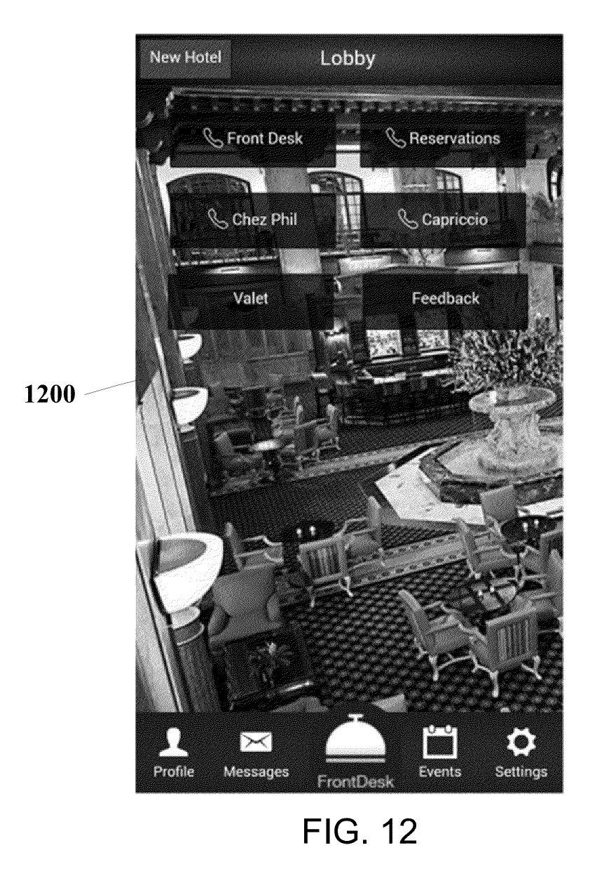

FIG. 9 displays one embodiment of a choose hotel screen 900 on an electronic device. Screen 900 may be utilized by a user to receive names of hotels on which a user may like more information. In embodiments, the hotel names may be input into a search bar found at the top of the screen 900. Once a user engages a search icon found on the search bar, the screen 900 may display search results below the search bar. In embodiments, the user may search for a hotel using parameters such as, but not limited to: hotel ID code, current location of the user, dropdown box displaying state, dropdown box displaying hotel, and previously saved hotel information. A user may engage an icon relative to any of the parameters and be redirected to an appropriate screen.

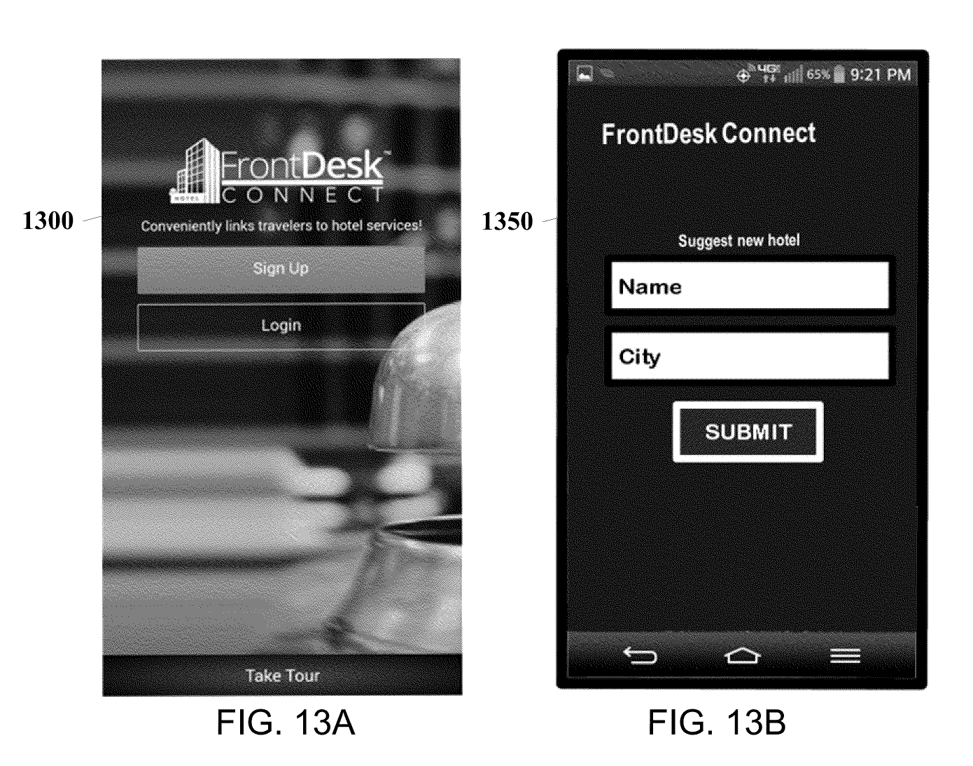

FIG. 10 displays one embodiment of a valet services screen 1000 on an electronic device. Screen 1000 may be utilized by a user to request a car for the user if the user needs to be driven to one or more specific locations. In embodiments, the last name of a user or a ticket number may be input into a first engageable section. A desired time for pickup may be entered into a second engageable section that may be found below the first engageable section. A request vehicle engageable icon may be engaged by a user once information is input into the first and second engageable sections. In embodiments, the user may enter either their room or ticket number and their last name on the screen 1000. Once the user has filled in the above information, the user may engage either the ASAP icon or fill in the “Time Requested” section so that a car may either arrive as soon as possible or may arrive at a time designated by the user.

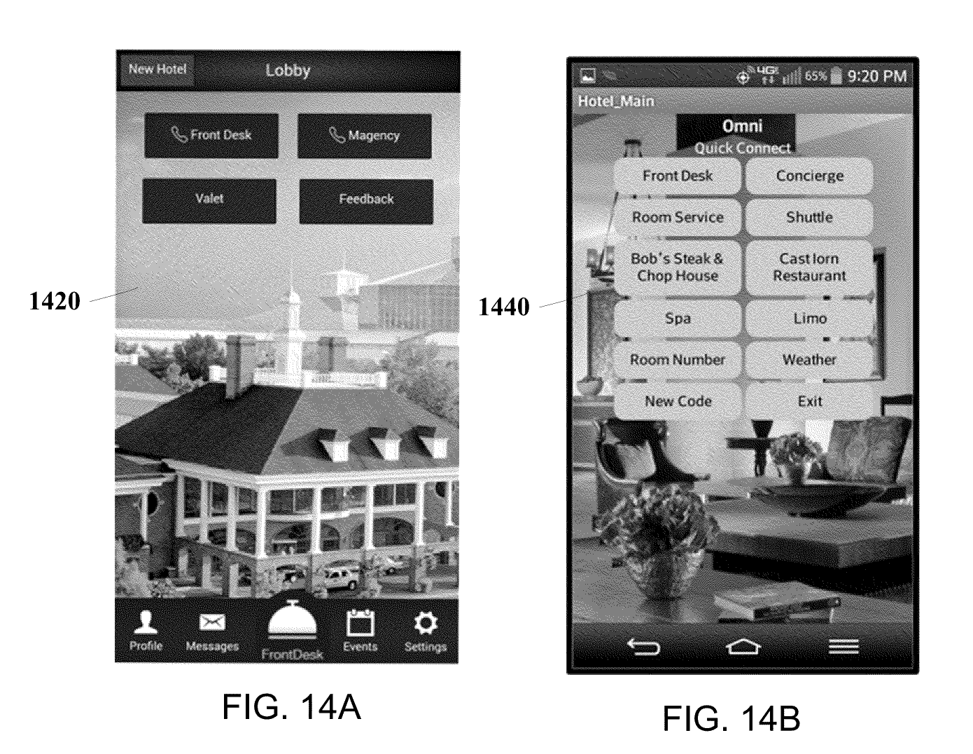

FIG. 11 displays one embodiment of a taxi services screen 1100 on an electronic device. Screen 1100 may be utilized by a user to request a taxi for the user if the user needs to be driven to one or more specific locations. In embodiments, the last name of a user or a ticket number may be input into a first engageable section. A desired time for pickup may be entered into a second engageable section that may be found below the first engageable section. A request vehicle engageable icon may be engaged by a user once information is input into the first and second engageable sections. In embodiments, the user may enter either their room or ticket number and their last name on the screen 1100. Once the user has filled in the above information, the user may engage either the ASAP icon or fill in the “Time Requested” section so that a taxi may either arrive as soon as possible or may arrive at a time designated by the user.

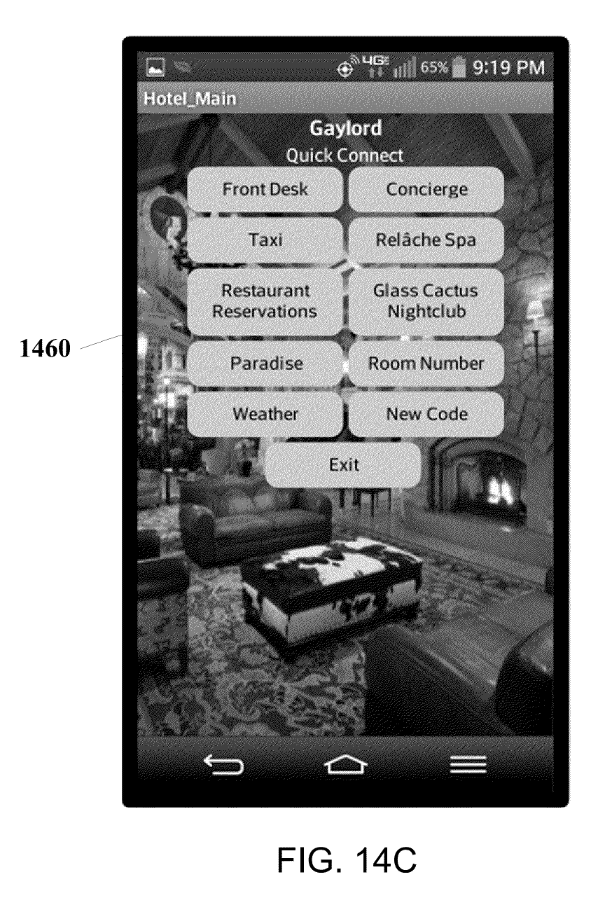

FIG. 12 displays one embodiment of a lobby screen 1200 on an electronic device. Screen 1200 may provide a number of icons that a user may engage in order to be provided with a service or information relative to the hotel. In embodiments, these icons may include, but are not limited to: a front desk icon, a reservations icon, a Chez Phil icon, a Capriccio icon, a valet icon, and a feedback icon. The screen may further include a new hotel icon found at the top of the lobby screen 1200. This icon may be engaged by a user if the user may like to search for another hotel other than the hotel associated with the lobby screen 1200. In embodiments, these icons may include, but are not limited to: a front desk icon, a reservations icon, a maid service icon, a concierge icon, a bell hop icon, a valet icon, a taxi icon, a set wake-up icon, a room number direct icon, and a local weather icon. The lobby screen 1200 may further include a push notification found at the bottom of the screen that may include, but are not limited to: a coupon or a shopping deal. In certain embodiments, the lobby screen 1200 may be absent a push notification.

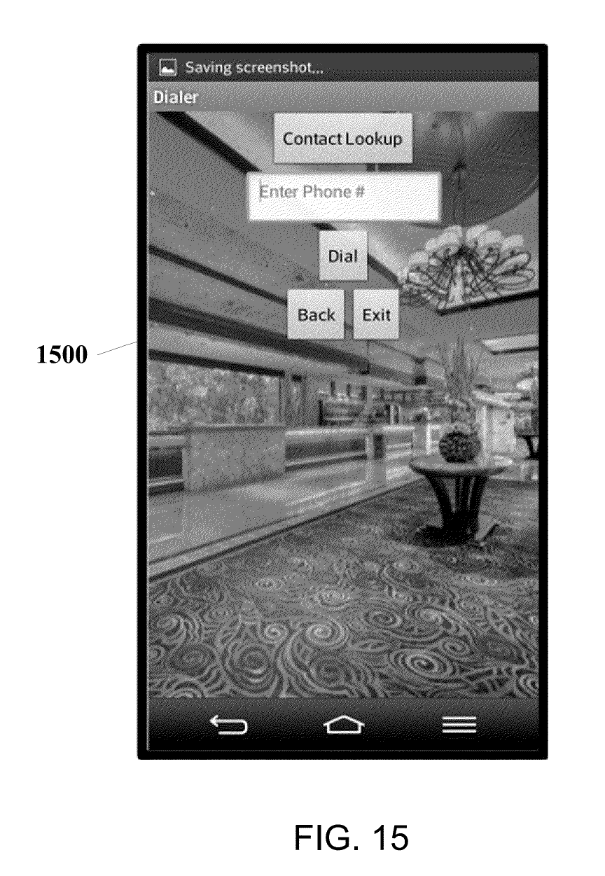

FIG. 13A displays one embodiment of a home screen 1300 for an application on an electronic device. Once a user engages an icon representative of the method and system for increasing utilization of hotel hospitality user services (such as the icon found in FIG. 3), the user may be led to the home screen 1300. In embodiments, the home screen 1300 may serve as a load screen. In embodiments, the home screen 1300 may be engageable, wherein a user may engage the screen 1300 and be led to a subsequent screen relative to the application representative of the method and system for increasing utilization of hotel hospitality user services. In embodiments, the user may engage a sign up icon in order to be led to a sign up screen or may engage a login icon in order to be led to a login screen. The user may alternatively engage a take tour icon found at the bottom of the page, wherein the user may be led to one or more alternative screens. FIG. 13B displays one embodiment of a hotel suggestion screen 1350 on an electronic device. The hotel suggestion screen 1350 may allow a user to suggest a new hotel that the database relative to the method and system for increasing utilization of hotel hospitality user services does not contain. The user may input the name and/or city of the hotel of which the user would like to suggest. Once the above information is entered into the screen 1350, the user may engage the submit icon in order to send the information to the database relative to the method and system for increasing utilization of hotel hospitality user services.

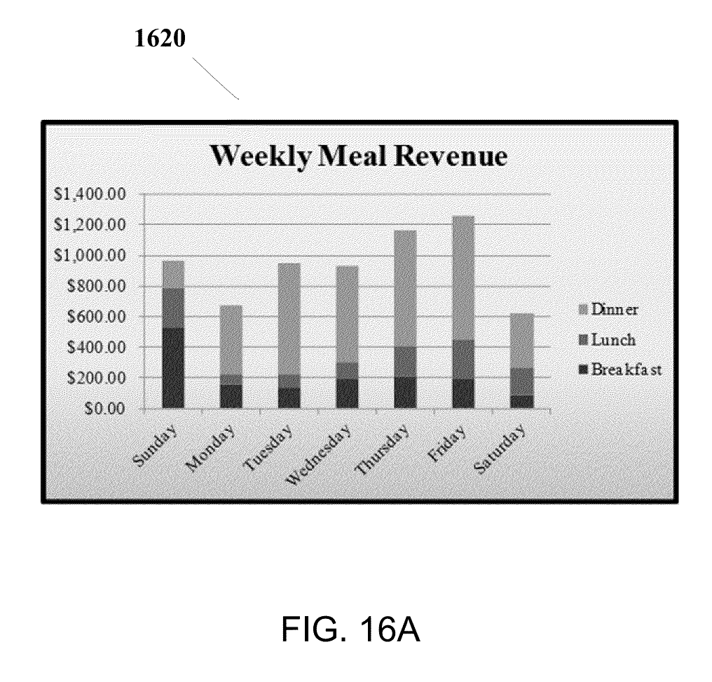

FIG. 14A displays one embodiment of an options screen 1420 on an electronic device. Screen 1420 may provide a number of icons that a user may engage in order to be provided with a service or information relative to the hotel with which the screen is relative. This screen 1420 may be similar to the screen infrastructure found in FIG. 12. The icons found on the options screen 1420 may include, but are not limited to: a front desk icon, a magency icon, a valet icon, and a feedback icon. The screen 1420 may further include a new hotel icon found at the lobby section of the screen 1420. This icon may be engaged by a user if the user may like to search for another hotel other than the hotel associated with the screen 1420. In embodiments, the options screen 1420 may further include a push notification found at the bottom of the screen 1420 that may include, but are not limited to: a coupon or a shopping deal.

FIG. 14B displays one embodiment of an options screen 1440 on an electronic device. Screen 1440 may provide a number of icons that a user may engage in order to be provided with a service or information relative to a specific hotel chain such as Omni Hotels® (a registered trademark of Omni Hotels Management Corporation) as depicted in FIG. 14B. This screen 1440 may be similar to the screen infrastructure found in FIG. 12 and FIG. 14A. The icons found on the options screen 1440 may include, but are not limited to: a front desk icon, a concierge icon, a room service icon, a shuttle icon, a Bob's Steak & Chop House icon, a Cast Iron Restaurant icon, a spa icon, a limo icon, a room number icon, a weather icon, an new code icon, and an exit icon. In embodiments, the options screen 1440 may further include a push notification found at the bottom of the screen 1440 that may include, but are not limited to: a coupon or a shopping deal. In embodiments, the infrastructure of the options screen 1440 on the electronic device may be utilized in conjunction with another hotel or hotel chain other than Omni Hotels®.

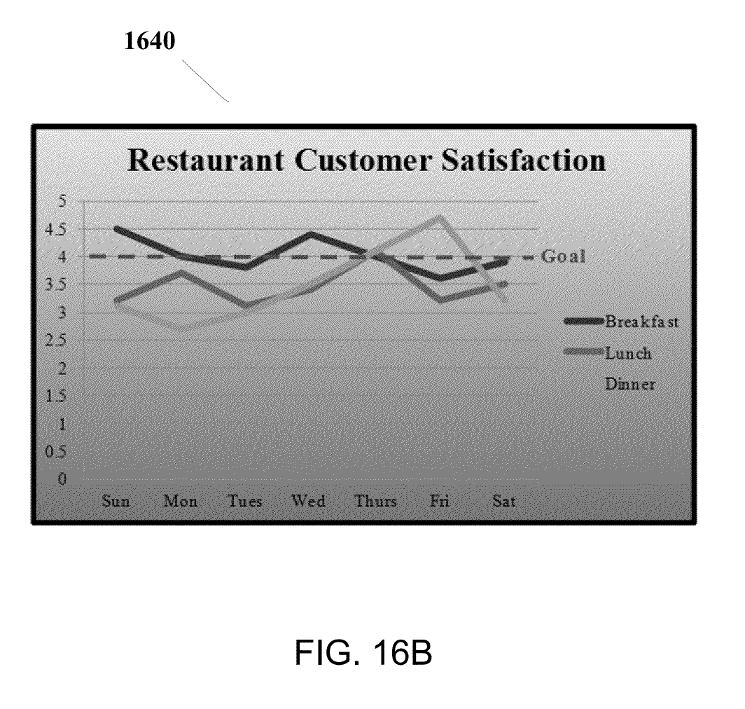

FIG. 14C displays one embodiment of an options screen 1460 on an electronic device. Screen 1460 may provide a number of icons that a user may engage in order to be provided with a service or information relative to a specific hotel chain such as Gaylord Hotels® (a registered trademark of Gaylord Entertainment Company) as depicted in FIG. 15C. This screen 1460 may be similar to the screen infrastructures found in FIG. 12, FIG. 14A, and FIG. 14B. The icons found on the options screen 1460 may include, but are not limited to: a front desk icon, a concierge icon, a taxi icon, a relache spa icon, a restaurant reservations icon, a Glass Cactus Nightclub icon, a paradise icon, a room number icon, a weather icon, an new code icon, and an exit icon. In embodiments, the options screen 1460 may further include a push notification found at the bottom of the screen 1460 that may include, but are not limited to: a coupon or a shopping deal. In embodiments, the infrastructure of the options screen 1460 on the electronic device may be utilized in conjunction with another hotel or hotel chain other than Gaylord Hotels®.

FIG. 15 displays one embodiment of a dialer screen 1500 on an electronic device. Screen 1500 may allow a user to either find a person relative to the hotel or contact a person. The user may engage a contact lookup icon in order to find contact information of a person that the user is attempting to contact. The user may also enter a phone number of a person that the user is attempting to contact; the dial icon may then be engaged by the user in order for the electronic device of the user to attempt to contact the person that the user is attempting to contact. A back icon may be engaged by the use in order to direct the user to a screen previously displayed on the electronic device before the dialer screen 1500 had been displayed. An exit icon may be engaged by the user in order to direct the user to a screen other than the dialer screen 1500 displayed by the electronic device.

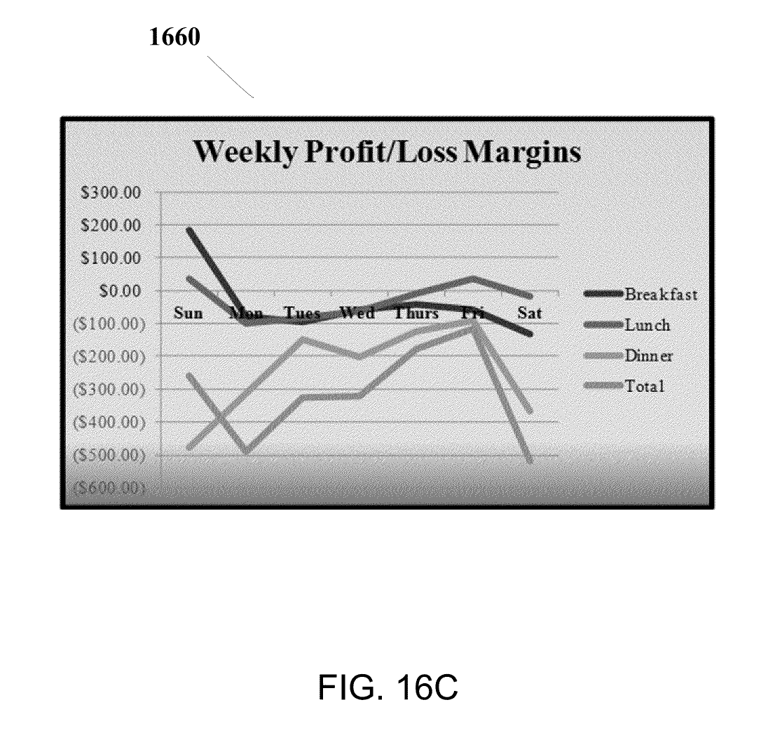

FIG. 16A displays one embodiment of a business weekly meal revenue graph 1620. This information may be collected by the processor and utilized by the method and system for increasing utilization of hotel hospitality user services. The revenue graph 1620 may be displayed on a screen of an electronic device of a person relevant to a hotel or hotel chain. FIG. 16B displays one embodiment of a business restaurant customer satisfaction line graph 1640. This information may be collected by the processor and utilized by the method and system for increasing utilization of hotel hospitality user services. The line graph 1640 may be displayed on a screen of an electronic device of a person relevant to a hotel or hotel chain. FIG. 16C displays one embodiment of a business weekly profit/loss margins graph 1660. This information may be collected by the processor and utilized by the method and system for increasing utilization of hotel hospitality user services. The margins graph 1660 may be displayed on a screen of an electronic device of a person relevant to a hotel or hotel chain. The above information may be informative to a hotel and may provide motivation to hotel staff to fix problems that may be found by interpreting the data.

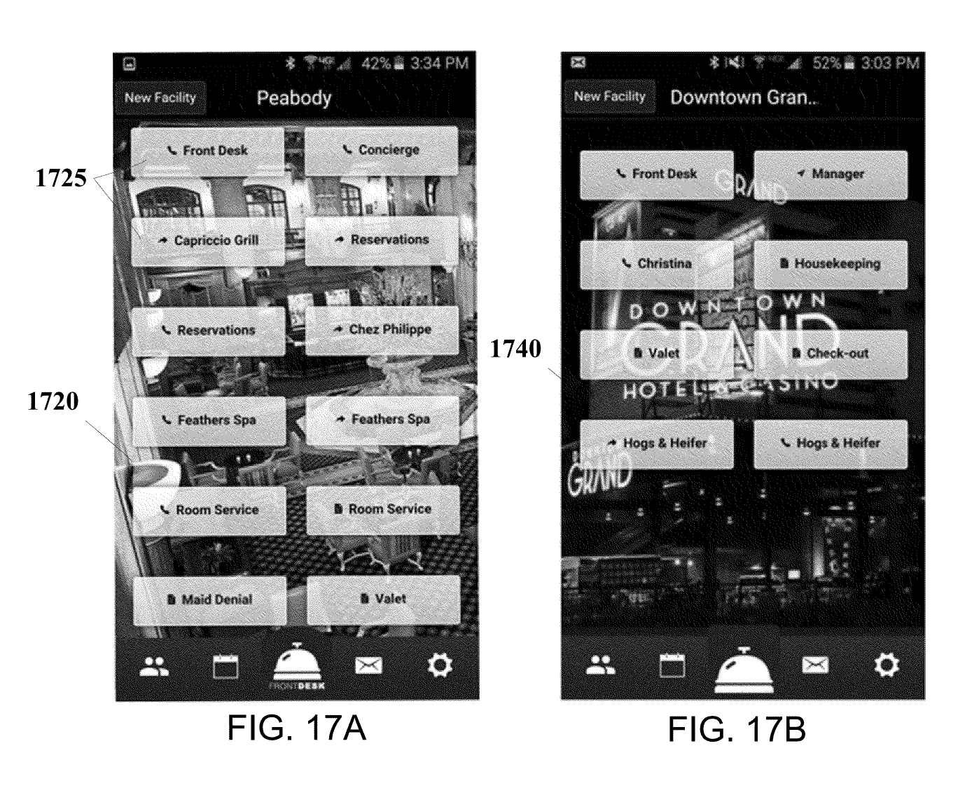

FIG. 17A displays one embodiment of a lobby screen 1700 on an electronic device. Screen 1700 may provide a number of icons that a user may engage in order to be provided with a service or information relative to the hotel. In embodiments, these icons may include, but are not limited to: a front desk icon, a concierge icon, a Cappuccino Grill icon, a reservations link icon, a reservations call icon, a Chez Phillippe icon, a Feathers Spa icon, a room service call icon, a room service form icon, a maid denial icon, and a valet icon. FIG. 17B displays one embodiment of an alternative lobby screen 1750 on an electronic device. In embodiments, icons found on the screen 1750 may include, but are not limited to: a front desk icon, a manager icon, a contact (Christina) icon, a housekeeping icon, a valet icon, a check-out icon, a Hogs & Heifer link icon, and a Hogs & Heifer call icon.

Each of the icons found on the screens 1700,1750 may comprise at least one of a denoting mark. The denoting marks may include a phone, an arrow, a form, and a curved arrow. When an icon includes a phone denoting mark, the icon may include shortcut calling functionality. For example, the front desk icon on the screens found in FIGS. 17A and 17B may act as a shortcut for a user of the electronic device displaying the screens 1700,1750 and may activate the function of calling the front desk of a hotel when the icon is engaged by the user. When an icon includes an arrow denoting mark, the icon may include shortcut email functionality. For example, the manager icon on the screen 1750 in FIG. 17B may act as a shortcut for a user of the electronic device displaying the screen 1750 and may activate the function of displaying an email message to the manager when the icon is engaged by the user. When an icon includes a form denoting mark, the icon may include shortcut form filling functionality. For example, the valet icon on the screens 1700,1750 found in FIGS. 17A and 17B may act as a shortcut for a user of the electronic device displaying the screens 1700,1750 and may activate the function of displaying a fillable valet request for on the display of the electronic device when the icon is engaged by the user. When an icon includes a curved arrow denoting mark, the icon may include shortcut link functionality. For example, the reservations icon on the screen 1700 in FIG. 17A may act as a shortcut for a user of the electronic device displaying the screen 1700 and may activate the function of bringing up a webpage when the icon is engaged by the user. These icons may provide convenience for a guest of a hotel by saving the guest time and energy searching for resources by providing shortcuts to resources that may potentially be utilized during a stay at a hotel.

The screens 1700,1750 may further include a new facility icon found at the top of the lobby screens 1700,1750. This icon may be engaged by a user if the user may like to search for another hotel other than the hotel associated with the lobby screens 1700,1750.

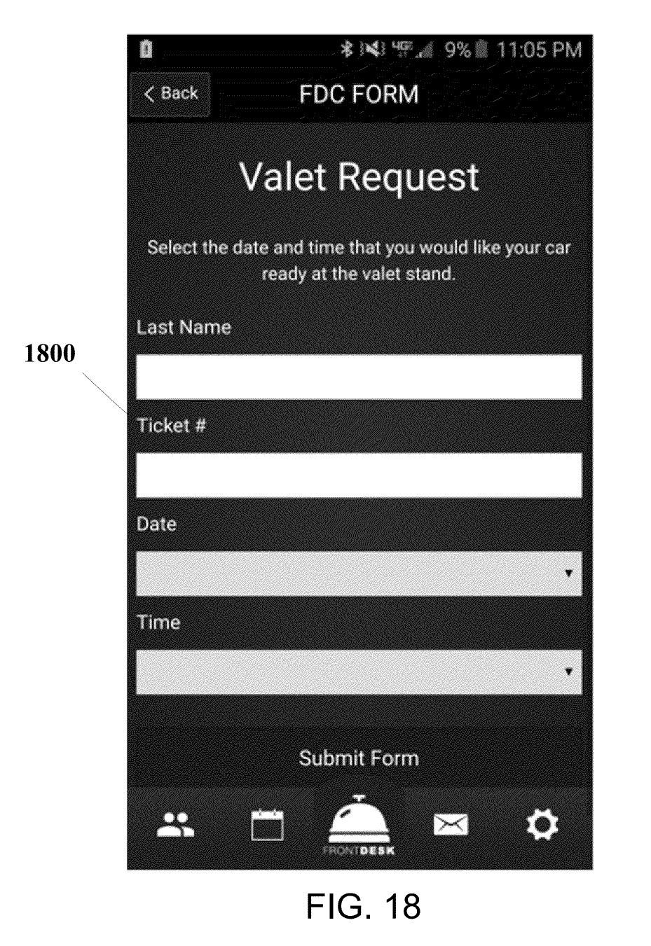

FIG. 18 displays one embodiment of a valet services screen 1800 on an electronic device. Screen 1800 may be utilized by a user to request a car for the user if the user needs to be driven to one or more specific locations. In embodiments, the last name of a user and a ticket number may be input into first and second engageable sections. A desired date and time for pickup may be entered into third and fourth engageable sections that may be found below the first and second engageable sections. In embodiments, the user may enter either their room or ticket number and their last name on the screen 1800. Once the user has filled in the above information, the user may engage the submit form icon in order to have the request sent to the valet service of the hotel.

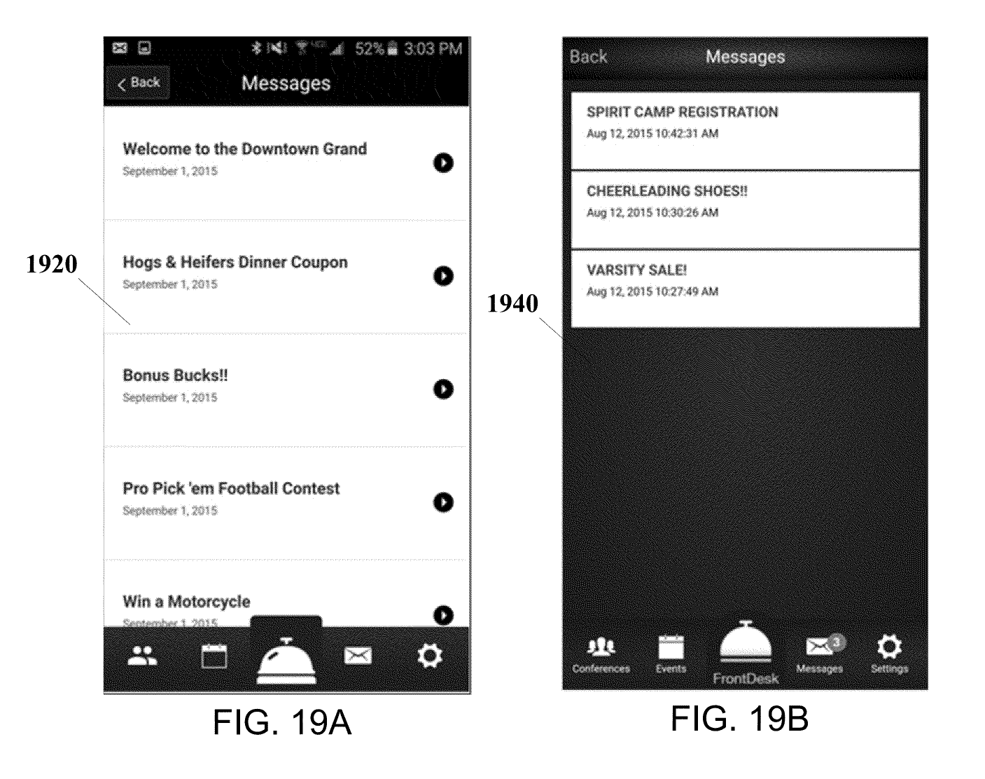

FIGS. 19A and 19B display embodiments of a messages screen 1920,1940 on an electronic device. When a user engages a mail icon on either of the bottoms of the screens 1920,1940 (denoted with an envelope), the screens 1920,1940 may display a list of messages received by the electronic device. The messages may be displayed one after the other and may be shown in chronological order. When a message is engaged by a user, the full text of the message may be displayed by the screens 1920,1940. In order to leave the message screens 1920,1940, a user may engage a back icon found at the top left of the screens 1920,1940.

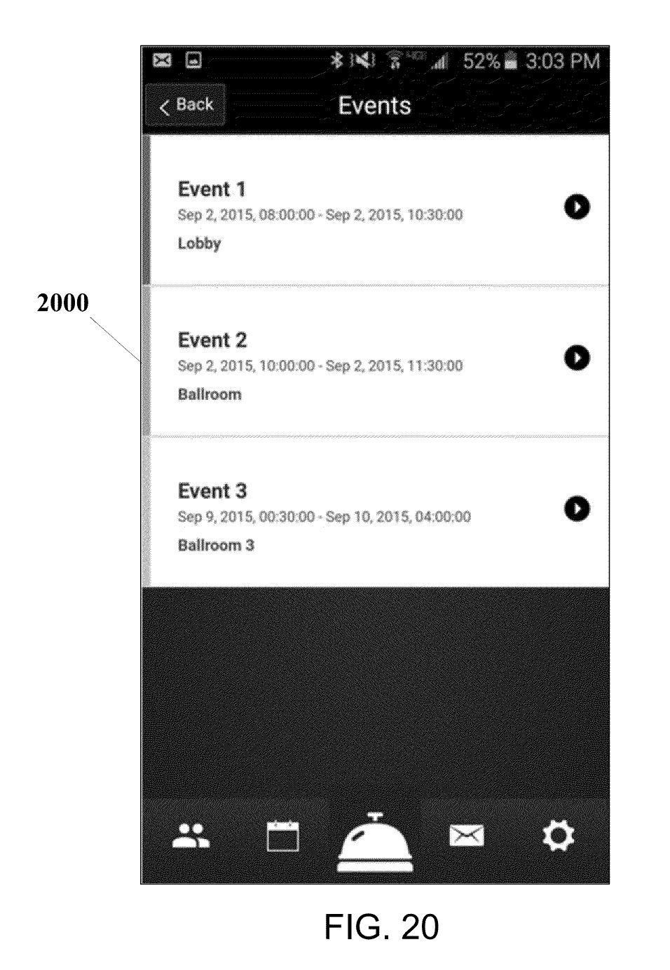

FIG. 20 displays one embodiment of an events screen 2000 on an electronic device. When a user engages an events icon on the bottom of the screen 2000 (denoted with a calendar), the screen 2000 may display a list of events that a user may plan on attending. The events may be displayed one after the other and may be shown in chronological order. When an event is engaged by a user, the full text of the event may be displayed by the screen 2000. In order to leave the events screen 2000, a user may engage a back icon found at the top left of the screen 2000.

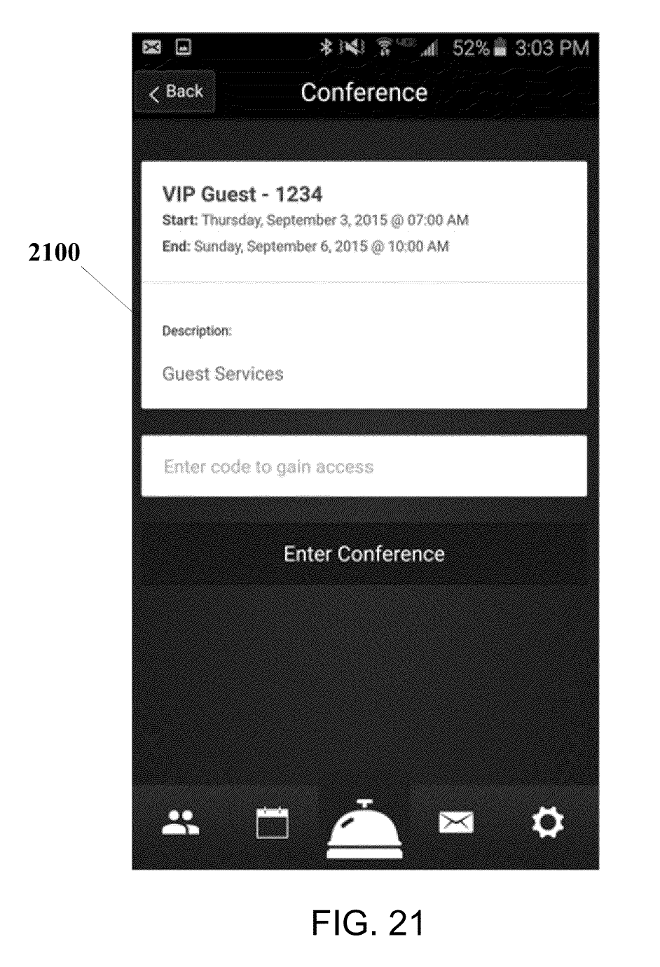

FIG. 21 displays one embodiment of a conference screen 2100 on an electronic device. When a user engages a conference icon on a screen 2100 (not shown), the screen 2100 may display details of an event, including the status of the user for the meeting and a description of what the meeting is about. A user may input an access code in an access code engageable section that may be supplied to the user by the hotel. Once a user inputs a code, the user may engage an enter conference icon. This may either allow access to a conference being held at the hotel or may alternatively connect the electronic device to a network that may include audio and video of the conference. In order to leave the conference screen 2100, a user may engage a back icon found at the top left of the screen 2100.

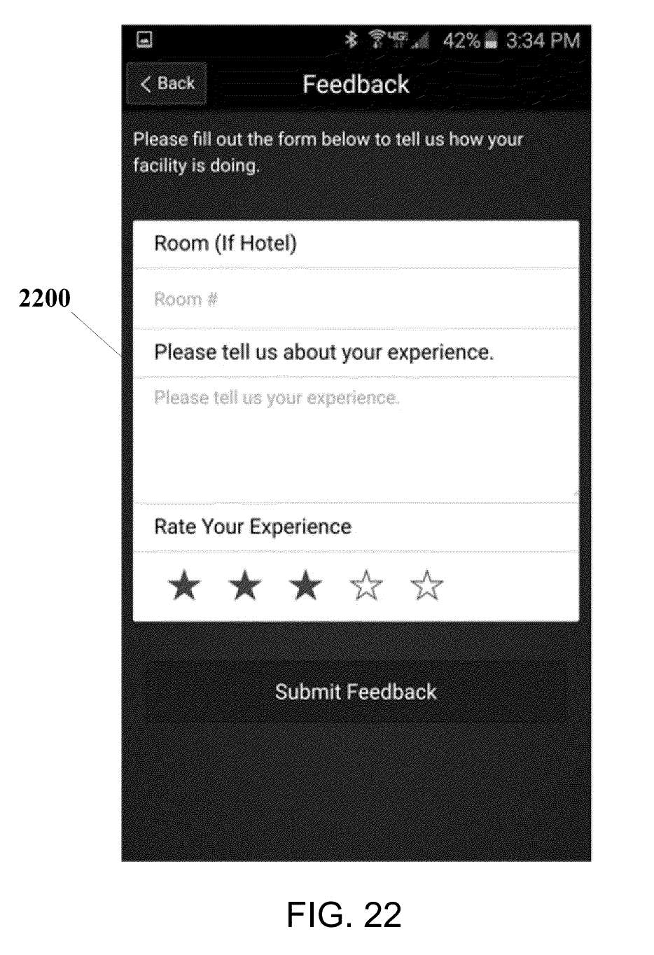

FIG. 22 displays one embodiment of a feedback screen 2200 on an electronic device. When a user engages a feedback icon on a screen 2200 (not shown), the screen 2200 may display engageable sections that may allow a user to input feedback information relevant to the hotel at which the user is staying. Input information may include, but is not limited to the room number of the user, details about the user's stay, and the amount of stars that the user thinks the hotel deserves (out of five). Once a user inputs feedback information, the user may engage a submit feedback icon. In order to leave the feedback screen 2200, a user may engage a back icon found at the top left of the screen 2200.

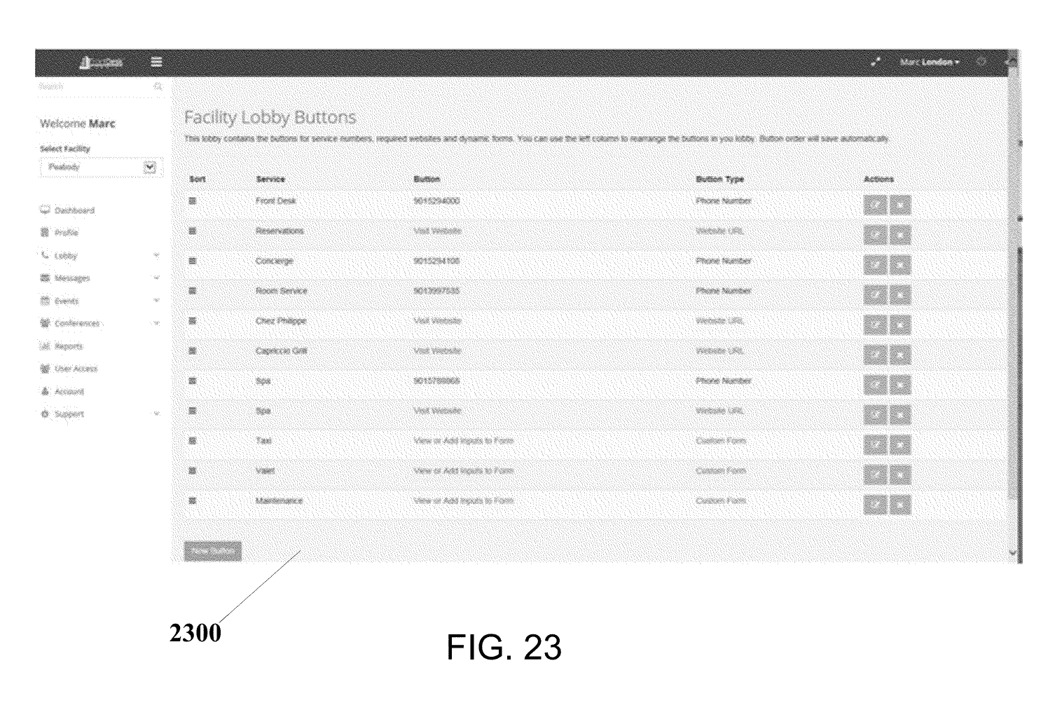

FIG. 23 displays one embodiment of a lobby buttons manager screen 2300 on an electronic device. Screen 2300 may be viewable on an electronic device of an employee of a hotel and may allow the employee to manage what a user may see when utilizing the system application on the user's electronic device. Identification of the logged in employee may be found at the top left and right of the screen 2300. In order to manage information of a hotel, the employee may select a facility from a drop-down menu on the upper left hand side of the screen 2300. As an example, on the screen 2300, the hotel “Peabody” is selected. Once a hotel is selected, all information displayed may be related to the chosen hotel (in this case, the Peabody). The employee may choose from a number of icons on the screen 2300 that may allow the employee to manage and/or edit information pertinent to the hotel. These icons may be positioned on the left side of the screen 2300 and may include, but are not limited to a dashboard icon, a profile icon, a lobby icon, a messages icon, an events icon, a conferences icon, a reports icon, a user access icon, an account icon, and a support icon.

Concerning the screen found in FIG. 23, the employee has engaged the lobby icon so a lobby screen 2300 is shown. The lobby screen 2300 may allow the employee to manage icons found within the system application and may control what icons are viewable on a user's electronic device. The screen 2300 may display five columns that may provide information concerning an icon and/or provide a functionality to the employee. The columns may include, but are not limited to a sort column, a service column, a button column, a button type column, and an actions column. The service column may display the title of an icon in rows and may include titles such as, but not limited to front desk, reservations, concierge, room service, names of restaurants, spa, taxi, valet, and maintenance. In order to edit any information found within the rows, the employee may engage an edit icon found under the actions column. The edit icon may allow the employee to amend information such as, but not limited to service title, the button functionality, and the button type. A delete icon found next to the edit icon may delete an entire row of information pertinent to an icon of a user's electronic device.

The sort column may comprise a pull-down tab for each service title and may allow the employee to put the service titles in a specific order. The specific order may affect how icons may be viewed on a user's electronic device. The button type column may allow the employee to classify icons for a user's electronic device. These classifications may provide certain functionality to the icons, such as calling a phone or providing a website URL. These classifications may include, but are not limited to a phone number classification, a website URL classification, and a custom form classification. The button column may provide specific information that may correlate with the classification of a service. The specific information may include, but is not limited to phone numbers, a visit website link, and a view or add inputs to form link. If an employee would like to add an additional icon, the employee may engage an new button icon found at the bottom left side of the screen 2300.

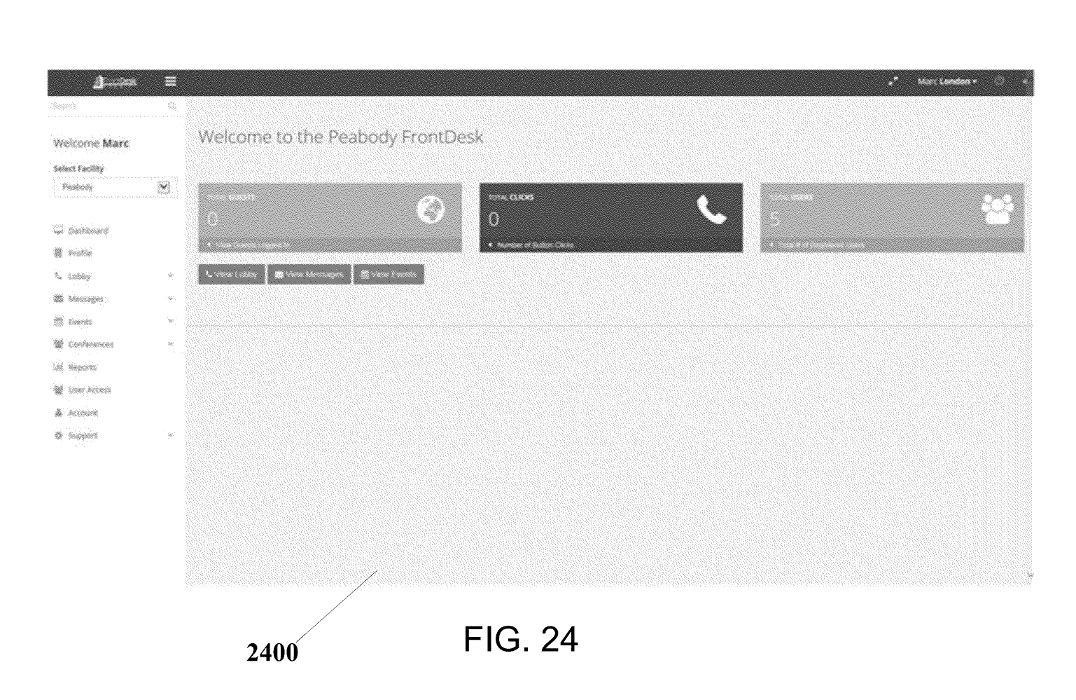

FIG. 24 displays one embodiment of a tracking analysis manager screen 2400 on an electronic device. Screen 2400 may provide information and icons similar to the screen found in FIG. 23. Similar information and icons found on this screen 2400 may include, but is not limited to identification of the logged in employee, a facility drop-down menu, and a number of icons that may allow the employee to manage and/or edit information pertinent to a hotel. The screen 2400 may additionally include a hotel profile section (in this case, for the hotel the Peabody). The hotel profile section may provide information concerning the total number of guests staying at the hotel, the total number of clicks for a certain icon in the system application, and the total number of registered users of the system application. If there are users of the system application that are logged in, an employee utilizing the screen 2400 may view the guests who are logged in to the system application. The screen 2400 may additionally provide a view lobby icon, a view messages icon, and a view events icon all correlating to the hotel displayed on the screen 2400. These icons may act as shortcuts to the content displayed when the correlating icons are engaged within the list of icons that allow the employee to manage and/or edit hotel information.

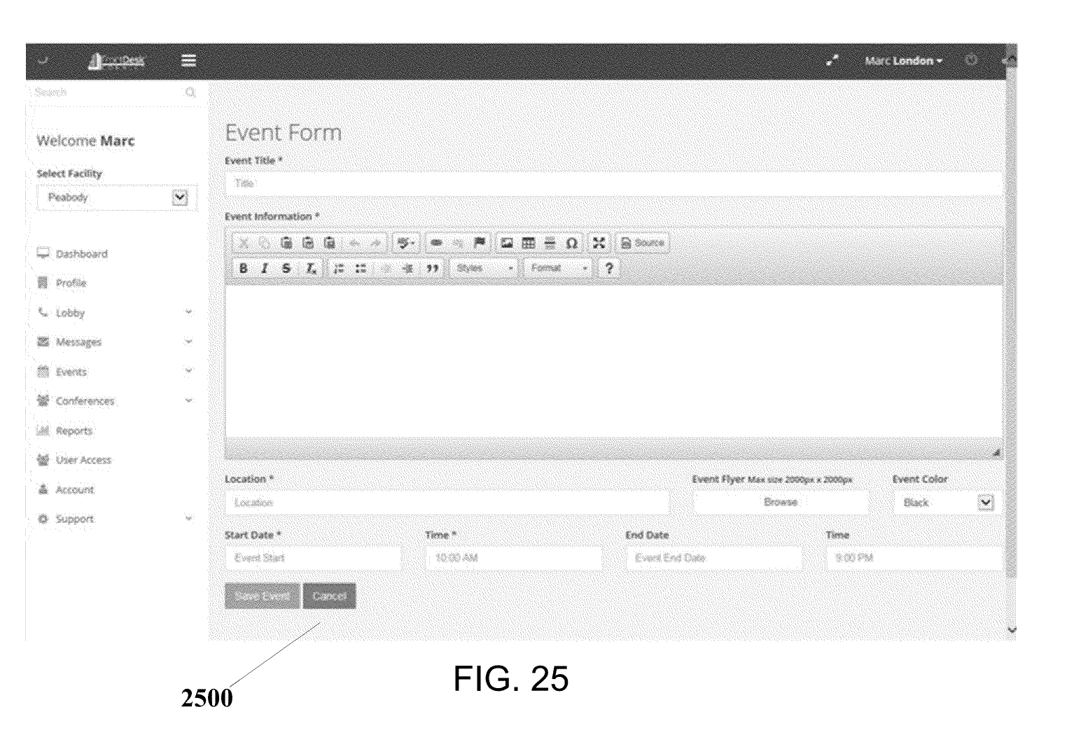

FIG. 25 displays one embodiment of an event form manager screen 2500 on an electronic device. Screen 2500 may provide information and icons similar to the screen found in FIG. 23. Similar information and icons found on this screen 2500 may include, but is not limited to identification of the logged in employee, a facility drop-down menu, and a number of icons that may allow the employee to manage and/or edit information pertinent to a hotel. The screen 2500 may additionally include an event form section (in this case, for the hotel the Peabody). The event form section may allow an employee to input information concerning an event and save the event. This information may be viewable on a user's electronic device when the user engages an events icon found at the bottom of a screen such as the screens found in FIGS. 17A, 17B, 18, 19A, 19B, 20, and 21. The information that an employee may input may include, but is not limited to an event title, event information, an event location, a start date, a start time, an end date, an end time, an event flyer, and an event color. In order to save information input by the employee, the employee may engage a save event icon found at the bottom left of the screen 2500. If the employee does not wish to save the information, the employee may engage a cancel icon found next to the save event icon.

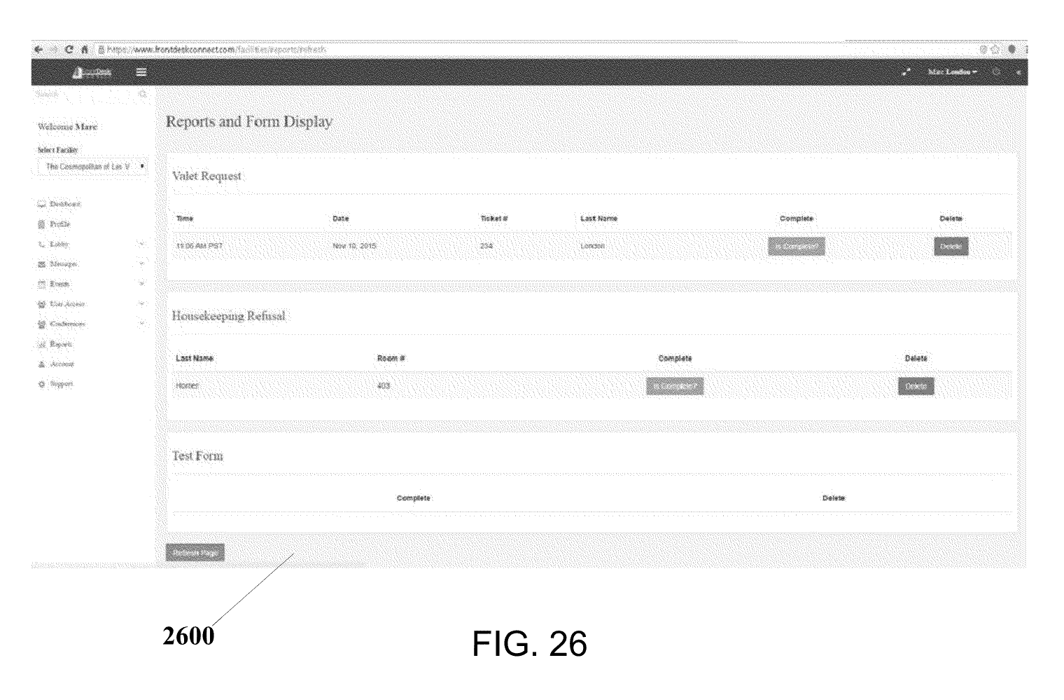

FIG. 26 displays one embodiment of a reports and form manager screen 2600 on an electronic device. Hotel employees may create forms including engageable sections that may be viewed by a user of an electronic device when the user engages an icon on a lobby screen (depicted in FIGS. 17A and 17B). Once these forms are filled out by a user, the form may be sent to and may be viewable by the employee via the hotel managing interface. The screen 2600 shown in FIG. 26 may be representative of a form notification checklist. The screen 2600 may show pending notifications/requests from users. If a task correlating with the notification/request is complete, the employee may engage a complete icon positioned within a categorized notification/request. If a task correlating with the notification/request will not be completed, the employee may engage a delete icon positioned within a categorized notification/request.

Operating systems utilized by any electronic device in conjunction with the disclosed method and/or system may include, but is not limited to: iOS 5 and later, Windows Phone 8.1, Windows 8, Android 4.3 and later, BlackBerry 10, Linux 3.4 and later through BlueZ 5.0, and Unison OS 5.2.

In embodiments, a screen of an electronic device relative to the method and system for increasing utilization of hotel hospitality user services may comprise engageable icons found at the bottom of the screen. The icons may include, but are not limited to: a profile icon, a messages icon, a frontdesk icon, an events icon, and a settings icon. When engaged by a user, each of the icons may each open an alternative screen on the electronic device that may be relative or not relative to any of the icons. In embodiments, one or more of the icons may not be located at the bottom of a screen.

In embodiments, the method and system for increasing utilization of hotel hospitality user services may be utilized in conjunction with an office building. As an example, an electronic device may comprise an interface specific to the office building that may include quick connect icons for specific offices. Another example may be an electronic device that may comprise an interface specific to an office in an office building that may include quick connect icons for rooms and/or cubicles found within the office. This may allow for a user of an electronic device to quickly and/or efficiently be in contact with a person pertinent to either an office building as a whole or to a specific office of an office building.

For the purposes of this disclosure, the terms “identified hotel guest user” “hotel guest user”, “guest user”, and “user” may be synonymous.

In embodiments, any of the screens displayed in the FIGS. may be displayed and/or function within any of the described systems, including user electronic devices.

In embodiments, a modifiable graphical interface component may be an icon, for example.

In embodiments, any of the disclosed methods and systems may be utilized for delivering hospitality services to users of services and facilities other than hotels.

1. A method for increasing utilization of hotel hospitality user services by hotel guest users, the method comprising:
providing a hotel managing interface via a server, the hotel managing interface comprising an application protocol interface, the application protocol interface accessible via a graphical user interface on a hotel electronic device, the hotel managing interface having a configuration adapted to receive and modify identified user service input, the identified user service input relating to at least one identified hotel hospitality user service;
receiving identified user service input via the hotel managing interface, the identified user service input determined in relation to predicted utilization of at least one of the hotel hospitality user services by an identified hotel guest user, the identified user service input determined via a processor by determining correlation between the at least one of the hotel hospitality user services and user information for the identified hotel guest user;
modifying, by the hotel managing interface, the identified user service input to create at least one modifiable graphical interface component;
sending, from the server over the network to a user mobile electronic device associated with the identified hotel guest user, the at least one modifiable graphical interface component, the user mobile electronic device having a user receiving interface comprising a graphical user interface;
displaying, via a display of the user electronic device, the at least one modifiable graphical interface component, each of the at least one modifiable graphical interface component comprising at least one link to the at least one of the hotel hospitality user services, the at least one link selected from the group consisting of:
a website URL, an email link, a telephonic link, and a modifiable form link;
receiving, at the user electronic device, user input relating to the at least one modifiable graphical interface component;
sending, from the user electronic device over the network to the server, the user input relating to the at least one modifiable graphical interface component; and
initiating, via the server, delivery of the at least one of the hotel hospitality user services to the identified hotel guest user;
wherein utilization of hotel hospitality user services by a plurality of hotel guest users is increased by recurring the initiating for each of a plurality of identified hotel guest users.

2. The method of claim 1, further comprising monitoring and collecting, via a user content tracking device, user input information on the user electronic device and user electronic device location information.

3. The method of claim 2, the at least one modifiable graphical interface component modifiable in response to the information collected via the user content tracking device.

4. The method of claim 1, further comprising receiving, via the user receiving interface, at least one specific modifiable graphical interface component in response to a unique user code input, the unique user code input providing protocol to the hotel managing interface for sending the at least one specific modifiable graphical interface component.

5. The method of claim 1, further comprising receiving, via the user receiving interface, at least one specific modifiable graphical interface component in response to a geographical location of the user electronic device.

6. The method of claim 1, the identified user service input comprising interactive notifications.

7. The method of claim 6, the interactive notifications received by the user electronic device in response to the location of the user electronic device within a local network of a hotel.

8. The method of claim 1, the hotel managing interface capable of altering destinations of a user response in response to the at least one of a website link, an email link, a telephonic link, and a modifiable form link based on an employee availability credential.

9. The method of claim 1, data provided to the user electronic device stored on the memory.

10. A system for increasing utilization of hotel hospitality user services by hotel guest users, the system comprising:
a server having a processor, the server providing a hotel managing interface, the hotel managing interface comprising an application protocol interface, the application protocol interface accessible via a graphical user interface on a hotel electronic device, the hotel managing interface having a configuration adapted to receive and modify identified user service input, the identified user service input relating to at least one identified hotel hospitality user service;
the hotel managing interface receiving the identified user service input, the identified user service input determined in relation to predicted utilization of at least one of the hotel hospitality user services by an identified hotel guest user, the identified user service input determined via a processor by determining correlation between the at least one of the hotel hospitality user services and user information for the identified hotel guest user;
the processor creating at least one modifiable graphical interface component by modifying the identified user service input;
the server sending over the network to a user mobile electronic device associated with the identified hotel guest user, the at least one modifiable graphical interface component, the user mobile electronic device having a user receiving interface comprising a graphical user interface;
the user mobile electronic device having a display of the user electronic device, the user mobile electronic device displaying the at least one modifiable graphical interface component, each of the at least one modifiable graphical interface component comprising at least one link to the at least one of the hotel hospitality user services, the at least one link selected from the group consisting of:
a website URL, an email link, a telephonic link, and a modifiable form link;
the user electronic device receiving via the user receiving interface user input relating to the at least one modifiable graphical interface component;
the user electronic device sending over the network to the server, the user input relating to the at least one modifiable graphical interface component; and
the server initiating delivery of the at least one of the hotel hospitality user services to the identified hotel guest user, the initiating determined by the processor correlating the at least one modifiable graphical interface component in relation to the at least one of the hotel hospitality user services and in relation to the identified hotel guest user;
wherein utilization of hotel hospitality user services by a plurality of hotel guest users is increased by recurring the initiating for each of a plurality of identified hotel guest users.

11. The system of claim 10, further comprising a user content tracking device for monitoring and collecting user input information on the user mobile electronic device and user electronic device location information.

12. The system of claim 11, the at least one modifiable graphical interface component modifiable in response the information collected via the user content tracking device.

13. The system of claim 10, the user receiving interface receiving at least one specific modifiable graphical interface component in response to a unique user code input, the unique user code input providing protocol to the hotel managing interface for sending the at least one specific modifiable graphical interface component.

14. The system of claim 10, the user receiving interface receiving at least one specific modifiable graphical interface component in response to a geographical location of the user mobile electronic device.

15. The system of claim 10, the identified user service input comprising interactive notifications.

16. The system of claim 15, the interactive notifications received by the user mobile electronic device in response to the location of the user mobile electronic device within a local network of a hotel.

17. The system of claim 10, the hotel managing interface capable of altering destinations of a user response in response to the at least one of a website link, an email link, a telephonic link, and a modifiable form link based on an employee availability credential.

18. The system of claim 10, data provided to the user electronic device stored on the memory.
